(19) United States
(12) Patent Application Publication
(10) Pub. No.: US 2026/0306915 A1
(43) Pub. Date: Oct. 8, 2026

(54) GOFAHOP

(71) Applicants: Francis Yinbrikeye Ogofa, Staten Island, NY (US); Mary Elizabeth Ogofa, Staten Island, NY (US); Sonoma Raye Ogofa, Staten Island, NY (US); Sophia Amelia Ogofa, Staten Island, NY (US)

(72) Inventors: Francis Yinbrikeye Ogofa, Staten Island, NY (US); Mary Elizabeth Ogofa, Staten Island, NY (US); Sonoma Raye Ogofa, Staten Island, NY (US); Sophia Amelia Ogofa, Staten Island, NY (US)

(21) Appl. No.: 18/800,106

(22) Filed: Aug. 11, 2024

(51) Int. Cl. A63B 47/02; B62B 3/10; B62B 5/06

(52) U.S. Cl. CPC A63B 47/021; B62B 3/10; B62B 5/06; B62B 2202/404

(57) ABSTRACT

GOFAHOP's unique characteristics are the basic fact that, (A) she has ARCHES at the base of her FRAME allowing tennis balls to pass under her; (B) a MOVABLE-TRAPPER serving as a nest, aiding in filling up her bin; (C) four very durable SPRINGS aiding the trapper with a vertical upward push, filling up her bin; (D) she rolls on WHEELS set upon pivotal SWIVELS and BEARINGS, enabling her to roll in all directions, eliminating the need to physically tote her bin, while collecting tennis balls; (E) two HIND BREAKS, locking her down when stationary, preventing her from rolling, in the event of strong wind or undulating surfaces; and finally (F) special HANDLEBARS that trigger the unique retrieval system/interconnecting chain reaction; making the process of ball hopping pleasurable. GOFAHOP's unique design and interconnecting chain reaction is the very bane of her novelty. It is what makes GOFAHOP . . . GO FAR . . . !

### STATEMENT REGARDING FEDERALLY SPONSORED RESEARCH OR DEVELOPMENT

not applicable.

### REFERENCE TO SEQUENCE LISTING, A TABLE, OR A COMPUTER PROGRAM LISTING COMPACT DISC APPENDIX

not applicable.

### BACKGROUND OF GOFAHOP: A DIVERGENCE FROM THE PRIOR ART

The present disclosure is generally related to systems, devices, apparatuses, kits, and methods associated with a ball picker. GOFAHOP (the given name of our invention) is a ball picking machine, used in the game of tennis, and can be applied to other sports as well. She falls under the umbrella of utility; and is designed to be an innovation within the sports industry. GOFAHOP was originally designed to take away all strains associated with collecting tennis balls, by providing an easy and pleasant experience during training sessions. This ease at collecting tennis balls we speak of . . . is contained within the unique baseline mechanism of GOFAHOP. From what we have observed, prior arts in this field will be ball hoppers such as Wilson, Gamma, Tourna, and Master Pro. In recent times, Hopparazzi Hopper, Vermont Roller Mower Hopper, and Tomohopper have been introduced into the market. However, what we have invented is radically different from that which is currently in existence, with the great advantage of potentially managing a sizeable, larger load capacity (thus giving vent to more practice time on the tennis courts and in other sports arena) easy storage/transportation (since she has bendable features) and finally, great mobility on the tennis courts and other usable arenas, with ease the wheels systems provide the user.

After years of close observation, within this field of endeavor, we discovered that there are ample evidence pointing to a whole slew of disadvantages, contained within the usage of existing “traditional tennis ball hoppers.” Therefore, in wanting so much to deviate from the strenuous, physically taxing manual usage of the “traditional” tennis ball hoppers, we decided to transition to a more mechanized system-hence the idea and eventual creation of GOFAHOP. We wanted tennis lovers across our globe to have fun and not feel the strain of picking individual tennis balls, whilst out there on the tennis courts. In transitioning into a more mechanized system, GOFAHOP became the point of divergence; the point where we defer from that which is “traditional” hopper.

For each ball captured and picked up by “traditional” hoppers, one must first manually lift one's basket off the ground (court) and then press down to collect a single tennis ball, doing this in a continuous repetitive motion for every single ball on the tennis court. One must then proceed to haul one's basket (full of tennis balls) across the tennis courts, for another bout of practice, thus giving discomfort to the shoulders, backs, elbows, arms, and wrists of users, who love and play the game of tennis. Keep in mind also that, as the basket gets filled up, it gets heavier and heavier.

In many instances, one's skin does get scratched and even slightly ripped, while lifting and carrying one's “traditional” tennis ball hopper. To paraphrase in reverse order, the very popular saying of the great controversial tennis professional—John McEnroe—we need to take these issues found in some of the prior arts, “very seriously.”

Every tennis court we visited or played at within New York's tri-state area and as far as Canada-we observed and noticed tennis lovers-adults, kids, senior citizens-straining and struggling to lift and carry along, their traditional ball hoppers filled with tennis balls, from their cars to the tennis courts. They then proceed to lift and carry their traditional ball hoppers, picking up tennis balls, with much strain and discomfort, the entire duration of their tennis drills.

With the invention of GOFAHOP, all that discomfort mentioned in the above paragraphs, becomes a thing of the past! The two catch phrases we came up with are: (1) “Strain no more, go at ease, and go far with . . . GOFAHOP!” We believe in our hearts that, (2) “GOFAHOP is the next generation of ball hoppers.”

Let's say for example, and for demonstration purposes, we have 100 tennis balls on the tennis court during a practice session. A tennis player, a hitting partner, a coach, a senior citizen, or a ball kid using the “traditional” tennis hopper, would have to first press down hard, then lift his or her “traditional” ball hopper, a hundred times off the court, whilst retrieving tennis balls. The carrier would then have to lift and carry his or her “traditional” hopper, filled with tennis balls, to the baseline, for another relay of practice drills.

Now multiply 100 tennis balls per 3 or 4 practice sessions, within those one or two hours mark alone. We are talking approximately over 300 to 400 tennis balls and over 300 to 400 press downs, lift-ups, and haulage per tennis session, per hour or more. Then comes the big drag—because, at that rate and at this point—a client (a recreational player, a professional coach, or a hitting partner) who is very tired, would be dragging their “traditional” ball hoppers across the tennis courts.

Whereas, with GOFAHOP, the strains of repetitive ball picking mentioned in the above paragraph are absolutely eliminated, because GOFAHOP does it all, for our targeted clients, with the simple push of a handlebar. In addition, the abrading of one's skin caused by the said “traditional” ball hoppers, during lifting and carrying while collecting tennis balls, becomes completely obsolete. GOFAHOP is the new hopper with unique features-features that set her apart. GOFAHOP's advantages rest upon her systemic process of mechanized chain reactions, not seen in “traditional” ball hoppers.

### BRIEF SUMMARY OF THE INVENTION: GOFAHOP

GOFAHOP's novelty and advantages which set her apart from preexistent hoppers, is the basic fact that she possesses a unique interconnecting retrieval system, while collecting tennis balls off tennis courts. Her mechanized chain reaction forms a process that eliminates all direct exertion of sheer human physical force: one of several purposes for which she was created. This above-mentioned mechanized chain reaction is also a capability the erstwhile “traditional” ball hoppers do not possess as seen explained in the ensuing paragraphs below.

GOFAHOP's unique and novel characteristics, are the basic fact that, (A) she has ARCHES at the base of her main BODY FRAME allowing tennis balls to pass under her; (B) a MOVABLE-TRAPPER/RETRIEVER that also serves as a nest, aiding in filling up her basket; (C) DURABLE SPRING SYSTEMS which aid the improved movable-trapper (now possessing vertical but crescent-shaped drive-prongs) with a vertical up and down pushing motion, while filling up her bin, so our targeted clients—lovers of tennis and the other various applicable sports lovers—do not have to press down, lift, tote and press down bins repeatedly; (D) she rolls on WHEELS set upon pivotal SWIVELS and BEARINGS, enabling her to roll in all directions, further eliminating the need to physically lift and tote bins, while collecting tennis balls; (E) 2 HIND BREAKS that locks her down when stationary, preventing her from rolling, in the event of a strong wind or undulating surfaces; (F) TWIN CYLINDRICALLY SHAPED rotating hubs on horizontal hind bars; (G) TWIN detachable, pronating, vertical but equally horizontally contiguous and extending BENDABLE-BARS; and finally (H) the various uniquely fashioned bendable TWIN HANDLEBARS that trigger the entire process—which is . . . GOFAHOP's exceptional interconnecting chain reaction and ball retrieval system-making every ball hopping experience, a pleasurable one. GOFAHOP's unique design and interconnecting chain reaction, triggered by her twin bendable handlebars, is the very bane of her novelty and the key to her practicality . . . the fundamental stuff, of which, GOFAHOP is made. It is what makes GOFAHOP do what she does. It is what makes GOFAHOP . . . GOFAHOP! With the modifications made to Alternate GOFAHOP I both on replacement drawing page 7/25, FIG. 5 and page 12/25, FIG. 10, she now has parallel vertical sliding bars, separate and apart from her regular handlebars/levers.

The above-mentioned chain reaction and interconnecting retrieval system, will be explained in more detailed format, in the ensuing paragraphs, under the title, “DETAILED DESCRIPTION OF GOFAHOP.” We would hitherto like to state here that with this new substitute specification . . . , after the initial designation of the springs within the ball retrieval systems as 7A, 7B, 7C and 7D (which are the starting point and bane of the entire springs systems specifically) . . . ; in regard to referencing the numerical characters for the rest of the 7 series, we are eliminating the alphabetical distinctions attached to such reference characters therein previously contained in the rest of the springs systems series i.e. 77A, B, C or D; and 777A, B, C, or D. We found this style of referencing to be too complicated. Henceforth, 77, and 777 are simply sufficient to describe the rest of these series. These mechanisms, no matter where they are found underneath the 4 flat panels (in the same four corners of GOFAHOP's legs) are in essence the exact same mechanical parts, protectively encasing the 4 springs, aiding the springs to perform their functions, and are similarly strategically located, within the 4 legs of GOFAHOP. Henceforth they shall just simply be referenced as no. 77 for the rubberized enclosures of the springs; and no. 777 for the splits of the protective cases no. 7PC. We value this simple universal designation to these embodiments of GOFAHOP, for they all function exactly the same way, no matter where (what corner) they are found. This way we keep it simple and less complicated. This same principle will apply to the wheels systems found in the legs of Alternate GOFAHOP 1 designated for the other sport types, like Golf, Baseball, and Softball. Field Hockey and Pickleball could share the same wheels-systems as tennis, because their terrains could be similar—that is—hard enough for smooth tracking and trapping. The only other exceptions are the existence of the durable sliding springs systems (nos. 7E, 7F, 7G, and 7H) of MODIFIED ALTERNATE VERSION IV.

Essentially, the huge advantage and selling point of GOFAHOP, is the fact that tennis lovers everywhere in the world, will no longer have to lift their ball hoppers, each time they retrieve a single tennis ball, all over the tennis courts. Concomitantly, they no longer must haul along . . . their “traditional” tennis baskets, full of balls, when they are done collecting all their tennis balls. GOFAHOP's two different sets of wheels and the above-mentioned mechanized system and chain reaction, catalyzed by the unique twin handlebars, will perform the job.

We would hitherto, quickly mention here, that we have equally created and invented a different and separate version from GOFAHOP, which we dubbed GOFAHOP-AIDER. AIDER falls under the banner of improvements; and we took the liberty to apply for her, 6 months earlier, on Feb. 19, 2024, in a separate provisional patent application. This particular provisional application which predates GOFAHOP's non-provisional application (Aug. 11, 2024) has some influence on GOFAHOP's original non-provisional application, such as the crescent shaped drive-prongs, and the way the springs systems function today. This basically means that as far as GOFAHOP is concerned, there are no new matters in our current substitute specification. Summarily, the current design and most plausible purpose of GOFAHOP-AIDER, is to give leverage to the aforementioned “traditional” tennis ball hoppers, using the below stated mechanisms from GOFAHOP, namely: (1.) the arches, (2.) the new and improved single movable-trapper/nest, (3.) the mature, but still evolving craft of the newly added prong-drives, (4.) the durable springs system and their compartments, (5.) the variant cylindrically shaped rotating hubs on horizontal hind bars, (6.) the various uniquely designed and reconstructed push around/push-down twin handlebars and (7.) the wheels systems at the base for easy mobility. Reflecting now, there may come a time when GOFAHOP-AIDER may be used for other purposes.

### DETAILED DESCRIPTION OF GOFAHOP

A regular tennis ball used in tournaments is about 6½-7 centimeters high, from the surface of the tennis court; therefore, for clearance purposes, we designed the height of GOFAHOP's arches- and here . . . we mean specifically just the arches (nos. 4A, 4B, 4C and 4D)—to be at least between 3 centimeters to 1 foot, directly higher than the highest point (top) of a stationary tennis ball.

To sum it differently, let's use the tennis court itself, as our mark and starting point vis-a-vis the arches. Directly rising from the surface of the tennis court . . . the height of GOFAHOP's arches (nos. 4A, 4B, 4C, and 4D) should be no less than 8½ to 9 centimeters at their highest points. However, for reasons of aesthetic appeal, the arches, and the entire base of GOFAHOP's bin (legs, springs, prongs, drives, and wheels) could be built higher than 9 centimeters; with 9 centimeters however, being the base-line requirement; because below that . . . it would be mathematically impractical, to capture and collect tennis balls; since the balls would have a grave difficulty getting through the arches and getting under the movable-trapper/nest, for ball retrieval. This also means that the springs and their components must be built with much elasticity, so that the movable trapper can reach and touch down onto the surface of the tennis court, to conveniently collect tennis balls. These components we are referring to are aided by the internal facilitative slits (no. 777) on protective case-panels (no. 7PC) which essentially serve the purpose of supporting the up and down motion of all of the vertical bars starting with—nos. 2A, 2B, 9A, 9B; and additionally, the concomitant contiguous horizontal bars—nos. 6A, 6B, 6C and 6D. We value the remodification of the prongs and drives (nos. 6DS) because they are a huge help and a guarantee that the movable trapper does indeed get to ground level and capture the balls. We say remodification because, the way the prongs look now, was in essence inspired by the bottom frontal horizontal linings of the grates of the movable trapper (nos. 12A and 12B) in FIG. 4, on replacement drawing sheet 6/25, which in all actuality, took its original from our first provisional patent application for GOFAHOP, two years ago. This thus means that this feature, as essential as it is . . . , is not a new matter. There are indeed no new matters; just the natural progression of ideation, evolving out of the pre-existent mechanical parts in the original applications, which gives vent to subtle modifications—procedural corrections if you may—meant to help our inventions do what they are created to do. We can safely say that, that original pre-existent FIG. 4, stood in potency of evolving into what it is today, that the ingredients which gave vent to what she is today, where already pre-contained from the very inception of her origins. Be aware also that some of the features described in our specification may appear in some of the drawings and not in others, either because they are assumed behind the walls of GOFAHOP's bin or they are not useful for the particular version. However, all features can be used universally (on a need-to-use basis), in regard to GOFAHOP or AIDER. Some features may even appear slightly different from other features, but function exactly the same way, and possess the same reference characters. It all depends on which version of GOFAHOP and what features or configuration we are describing and using at the time; plus, the felt need.

GOFAHOP's main wheels do contain roller bearings within them, for easy flexible movement in any direction while collecting tennis balls. The hind wheels do have brakes to prevent GOFAHOP from rolling, in the event of a strong wind or undulating surfaces. These hind breaks should be easily triggered and untriggered using one's foot. The frames on the sides of all wheels are to have a red metal or silver outer (top) layer and a green metal or silver inner (middle) layer, a centralized silver hub and an overall black or gray rubber overlay. We suggest rubberized wheels, simply because they may cause incredibly minimal, to zero damage, to the surface of tennis courts.

To prevent GOFAHOP from knocking tennis balls all over the courts, without really collecting them, we designed her with arches (nos. 4A, 4B, 4C and 4D) at the base of her bin. This is a very crucial part of this invention. The arches provide an entrance for tennis balls passing directly underneath GOFAHOP's bin (no. 14A) and into her movable-retrieval nest (nos. 12A and 12B) making it easy for her to track, trap, collect, and fill up her bin with tennis balls. Her arches must not be narrow. They should have a wide expanse from leg to leg, giving enough room for more tennis balls. At least, that is our objective. In our original specifications, we made the mistake of naming the bin as both no. 1 (with the baseline hauler in a few modified versions as no. 001). Henceforth we are renaming GOFAHOP's bin as 14A, and the inner bin in other modified versions as 14B. The only exception is no. 001 which stands in reference to the baseline hauler specifically.

Encased within GOFAHOP's bin, is the improved movable trapper/retrieval nest (nos. 12A and 12B) which should be red or the same color as her bin. We here say improved because, during the process of ideation for the movable trapper/retrieval nest for The Aider-which actually, was originally and previously inspired by FIG. 4 of GOFAHOP herself (sort of in a cyclic movement)—we made a remodification and a major improvement of the drop-down prongs—again, pre GOFAHOP's non-provisional application-thus solving the issue of . . . , and ensuring that the movable trapper gets to ground/surface level. These remodified drop-down prongs could be found, in our previous provisional application for GOFAHOP-AIDER, [application number 63/555,291; with application date Feb. 19, 2024], which certainly pre-dates GOFAHOP's non-provisional patent application, 6 months later, on Aug. 11, 2024. This thus means that, at the time of the initial non-provisional patent application of this invention, the prongs and the springs systems that go with them were already in potency; already set in place; they, therefore, are currently not new matters. The function of the movable-retrieval nest is to trap tennis balls, aided by these drop-down prongs . . . in addition to her four springs, that are crested within four rubberized roundish tubular compartments (no. 77) inside GOFAHOP's four legs. These rubberized tubs do protect the springs and prevent leaks on the tennis courts, as the new and improved movable trapper, pushed down by the prong-drives, slides up and down, grabbing and filling up her bin with tennis balls.

GOFAHOP has four very durable springs nos. (7A, 7B, 7C and 7D) in all four corners of her legs, encased within the above mentioned slightly (internally) greased 4 rubberized roundish, compressible, tubular compartments (no. 77) which prevents leaks on the tennis courts, right underneath the movable-trapper's 4 extended flat panels (nos. 8A, 8B, 8C and 8D). The function of the four springs is to provide a rebounding vertical up-push motion to the movable-trapper/retrieval nest (nos. 12A and 12B) once the tennis balls have been grabbed and retrieved. With this vertical “springy” up-push motion, her bin gets filled up with tennis balls.

The springs can be easily replaced periodically as needed; probably once every 5 to 6 years or 7; or even more—depending on how durable they are constructed. Moreover, to preserve their life span, springs may be cleaned and re-greased from time to time as needed, when GOFAHOP is not in use. Taking this measure prevents rust from happening. Which means, the springs should be made to be uncoupled and recoupled with ease.

Both the movable-trapper and the springs are very crucial parts of this invention, for without them, GOFAHOP will not be able to function and give us desired results. The arches are also very crucial, because without them, the tennis balls would not be able to get under GOFAHOP's bin. All bins in every version of GOFAHOP have lids to prevent runaway balls from rolling all over during transportation.

All 4 round flat panels (nos. 8A, 8B, 8C and 8D) within GOFAHOP's 4 legs, are an actual extension of and the end points of the movable-trapper's facilizing horizontal bars (nos. 6A, 6B, 6C, and 6D) and are directly situated above and over all 4 springs, for easy press down by both the bendable major twin handlebars (nos. 2A and 2B) and the smaller rotatory bars (nos. 9A and 9B) to track, trap, and collect tennis balls. The four springs underneath the panels are encased within 4 protective panels (no. 7PC), which have splits (no. 777) that are meant to help facilitate with ease the horizontal bars (nos. 6A, 6B, 6C, and 6D) and thus the movable-trapper's vertical up-down/down-up sliding motion.

Another great feature which we intend to claim . . . is the fact that every variation of GOFAHOP has her own unique and specific bendable twin HANDLEBARS (nos. 2A and 2B) which triggers the entire process. We made them bendable for easy storage/transportation purposes. These twin bendable handlebars are in essence the push around handlebars with a concomitant dual purpose of serving as the push down lever, bringing the desired results of collecting tennis balls into full effect.

Directly touching the horizontal hind-bar (no. 6C), and thus the prongs (nos. 6DS), and thus the thin but hard metal frame of the movable-retrieval nest (nos. 12A) from behind, and originating from the two main bendable twin handlebars (nos. 2A and 2B) are two other distinct, detachable, pronating, vertical but equally horizontally contiguous and extending bendable bars (nos. 9A and 9B) with rotating locked-in joints, which function, is to directly push down from behind, on the said horizontal hind-bar (no. 6C) that overlays both the prongs and the movable-retrieval nest, giving more leveraging downward push to it, with the design and intent of aiding in the trapping and retrieval of tennis balls.

For GOFAHOP ((ALPHA) that is FIGS. 1, 2, 3A, 3B and 3C) alone, these two side by side contiguous, detachable bars (nos. 9A and 9B) mentioned above, can snap off from the overlaying hind-bar (no. 6C), spin upwards to the top, and become one with the main push around/push down twin handlebars (nos. 2A and 2B) by meshing and clicking into the semi hollowed (oval) compartments (10A and 10B) of GOFAHOP ALPHA. They are sky blue in color just like the main handlebars; and because they have joints and sockets, they can pronate and mesh into the main handlebars easily, in preparation for the ultimate rotation that sets the entire bin, filled with tennis balls, into a standing position as shown in FIGS. 3A, 3B, and 3C. Permit us to quickly mention here that, albeit colors are great for design purposes and are aesthetically appealing to the eyes of the beholder, they are nonetheless primarily suggestive. Colors can be changed on a whim and periodically too.

Furthermore, while possessing the ability to pivot and rotate into a standing position, thus bringing the entire bin to a comfortable waist level; the main bendable handlebars (nos. 2A and 2B) also have another set of smaller wheels (nos. 13E, 13F, 13G and 13H) inserted into them, with bearings, so that one can easily move GOFAHOP's bin full of balls, to any part of the tennis court, without lifting her whatsoever. These could be rollerballs sort of wheels as well. They also do have brakes of their own, to keep GOFAHOP stationary, while practice sessions are ongoing.

Moreover, to aid the main twin bendable handlebars to perform their function, we created two rotating cylinders (reference nos. 3A and 3B) nestled around and cast over a contiguous horizontal bar (no. 5) that is attached to GOFAHOP's main body frame (no. 14A) from behind, but without touching the frame. The two cylinders (nos. 3A and 3B) conversely encase the same said long contiguous horizontal bar (no. 5) with a space between this bar and the body-frame of GOFAHOP itself. The horizontal bar (no. 5) and the rotating cylinders (nos. 3A and 3B) not touching the back or body of GOFAHOP's bin help facilitate rotation of the handlebars.

These cylinders do have a triple purpose. (1) Their first function is to aid the handlebars (nos. 2A and 2B). (2) Their second function is to aid the ancillary bar (nos. 9A and 9B) to push down on the single improved movable-trapper (nos. 12A and 12B) thus aiding in the process of collecting tennis balls. (3) Their third function-(only for GOFAHOP FIG. 1, FIG. 2, FIG. 3A, FIG. 3B, and FIG. 3C)—is to aid in facilitating the rotating process of the same main-handlebars (2A and 2B) and the bin (no. 1) filled entirely with tennis balls, pronating 180 degrees, into a standing position, using joints, and/or elbows as determined by the constructing engineers, and by so doing, bringing GOFAHOP's bin to a comfortable waist level, for easy ball selection and practice.

We do appraise GOFAHOP's unique twin (main) handlebars (nos. 2A, 2B, 2C, 2D, 2E and 2F) because of the special role they play in the entire mechanism referred to above. They do serve the dual purposes of a push-around handlebars and a push-down lever, bringing the desired result of collecting tennis balls to fulfilment. The way the twin handlebars function in picking up tennis balls is truly remarkable! They are the starting point of GOFAHOP's success as an inventive idea/apparatus; and very vital parts of GOFAHOP's originality; fundamentally setting her apart from the erstwhile “traditional” tennis ball hoppers or any other ball hopper we've ever seen, within this field of play. They also make for easy transportation and storage when GOFAHOP is not in use.

In essence, from the above descriptions, one can easily deduce that the entire mechanism of GOFAHOP's chain reaction in collecting tennis balls off tennis courts, is deeply dependent upon these 7: (a.) the arches; (b.) the improved movable trapper/retrieval nest, with the mature, but still evolving craft of the newly improved drive-down-prongs, pre-non-provisional application; (c.) the various durable springs systems and their compartments; (d.) the newly improved cylindrically shaped rotating hubs; (e) the contiguously extending horizontal bar behind GOFAHOP's frame or bin; (f) the two distinct detachable, pronating, vertical but horizontally contiguous smaller bendable bars; and finally (g.) the variant unique main twin handlebars-which by a simple forward and downward push, automatically puts into motion, the aforesaid chain reaction and desired result of filling up her bin, for easy tennis practice.

The above itemized mechanisms are all very crucial parts of GOFAHOP—vital to her novelty—for without them, GOFAHOP would not be able to function or fill up her bin with tennis balls. These are the mechanisms that have fundamentally set GOFAHOP apart, from the erstwhile “traditional” tennis ball hoppers or any other ball hopper we have seen, within the sports industry.

### Composition of Material

Ultimately, the composition of GOFAHOP's main haul or bin (frame) could be any of the following materials, in the order of preference we have in mind:
Metal
stainless steel
Aluminum
Plexiglass
Polypropene; and lastly,
translucent (recycled) plastic (of a solid nature.)

### Expatiation of the Above Paragraph/Bulleted Points

GOFAHOP's bin should be a non-heavy but durable solid material. Be aware that in some versions of GOFAHOP, particularly FIG. 1, FIG. 8, and FIG. 9 (but not in others) her bin could be composed of two parts: (A) the baseline hauler (no. 001) and (B) the rest of the bin itself (no. 14A). These two (no. 001 and no. 14A) can be used one without the other; interchangeably; or together, depending on the felt need. Therefore, we prefer metal as the main material for the base/hauler (no. 001) wherever she is found. However, aluminum, which is a lightweight but very sturdy material, could be a huge contender to metal, for GOFAHOP's base (nos. 001) wherever and whenever we chose to have and apply that unique base, for extra support and stability. Stainless steel is also a huge contender to metal. However, regarding the hauler (no. 001) we are more inclined to lean towards metal-a metal that is treated-solid, but not overtly heavy, since it gives stability to the bin and the entire mechanism. This also means that the weight of the handlebars (nos. 2A and 2B) must be commensurate with the combined weight of the baseline hauler (no. 001) and the bin (no. 14A).

To be clear, a metal bin must have a metal base/hauler. A stainless-steel bin or an aluminum bin may have stainless steel base/hauler and aluminum base/hauler respectively—or a metal base/hauler, ultimately. Other than these three, and for clarity purposes, any other material chosen by the skilled engineer, for the construction of GOFAHOP's main body-frame—by a good standard and for reasons of durability—it is advisable that metal be used for the bin (no. 14A and/or baseline hauler no. 001).

This requirement is essential, because the hauler, in addition to encasing the movable trapper, the 4 durable springs, and the first set of wheels (nos. 13A, 13B, 13C, and 13D) also holds in place the twin handlebars whilst maintaining her arch shape on all four sides. To put it another way: metal, stainless steel, and aluminum, do stand as a class unto themselves; but could last longer if metal is used as the main base for GOFAHOP and her derivatives.

A TABULARIZED CLARIFICATION
OF PARAGRAPHS 0040-0043

| MATERIAL | BIN | HAULER | |
|---|---|---|---|
| METAL: | METAL | METAL | |
| STAINLESS | STAINLESS | METAL | STAINLESS |
| STEEL: | STEEL | | STEEL |
| ALUMINUM: | ALUMINUM | METAL | ALUMINUM |

| | | |
|---|---|---|
| PLEXIGLAS: | PLEXIGLAS | METAL |
| POLYPROPENE: | POLYPROPENE | METAL |
| TRANSLUCENT | TRANSLUCENT | METAL |
| RECYCLED | RECYCLED | |
| PLASTIC: | PLASTIC | |

Put in mind that the baseline hauler (no. 001) if one is had . . . it is encouraged for it to be metal because it holds in place all the bottom mechanisms and the handlebars. As the chat above points out, the skilled engineer could make the bin (no. 14A) with polypropene, Plexiglas, or plastic from recycled materials-any solid color of his or her own choice. Be they metal, aluminum, stainless steel, plexiglass, polypropene, or translucent recycled plastic, they could be made with various colorful designs as well. The colorful designs could be camouflage of varying displays; scenic pictures of the natural beauty of our world; or interstellar displays of distant nebulas and galaxies; the birth of a new star, the death of an old star-a supernova- or a newly discovered planet, that may be able to sustain life. Basically, any new discoveries of our space age. It could also be pictorial depictions of all the superpowers of our home (earth) and all nations working together to ensure the survival of humanity and not tearing each other apart. It could be pictorial depictions that send messages which point to the antecedent beauty of our historical scientific past . . . and a pointer to the beauty of our future if we work together amicably . . . a nostalgia, a longing for . . . as well as an anticipatory portrayal of the consequential evolutionary manifestation and actualization of humanity's future. What would . . . or what should . . . that future look like? A message that urges us to seek real and true integration within the beauty of our diversity, working together as one human family, leaving no nation or race of people behind, with a united manifest destiny: the survival of our kind. All these “symbolisms” and much more, to be seen by millions, if not billions of people . . . within the world of tennis . . . through the eyes of a simple ball machine-GOFAHOP!

We also intended that GOFAHOP comes in all 4 colors of all 4 Majors—Australian, French, British and The U.S. Open. She could be constructed and designed in myriads of other colors and shapes—such as camouflage of various colorful spectrums, et cetera—or the mascots of different Universities, Colleges and High Schools, that may want to personalize their GOFAHOPs. They could be constructed to fit the culture, mood, sentiment, or taste of individual clubs, tennis academies or other entities across our globe, that love and play the game of tennis.

We would however like to reiterate here, that colors and sizes are mainly suggestive, and for aesthetic appeal. It is the idea of GOFAHOP, how she functions, and what benefits she brings to the world of tennis, which really counts the most. We could, for example, decide tomorrow or next year, or the year after, TO construct GOFAHOP in an entirely different shape—round for instance or rectangular, or triangular with an iguana-like motion. The point is, what really matters the most, that which is primus to GOFAHOP as a creative idea—that which is the fundamental stuff of GOFAHOP as an invention . . . is her working mechanisms, her long-lasting functionality, her ruggedness, her durability; the novelty she brings to the world of tennis . . . ; not so much her colors or her shape.

In addition to plexiglass and translucent plastic having the added advantages of being very colorful and aesthetically appealing, one can also see through and decipher an estimated number of tennis balls still left in the bin. As far as plexiglass, polypropene, and translucent recycled plastic are concerned, we recommend that the material composition of the base, should be metal, since it contains the movable-trapper and all of the springs' components; whilst holding in place, the first set of wheels and brakes, as well as the arches.

If the manufacturing engineer decides to go strictly all out aluminum, that is okay too. It will be interesting to see how comfortably well an all-round aluminum hopper with an aluminum base holds the baseline mechanisms of GOFAHOP and still functions beautifully to produce desired results. However, no matter which material composition is chosen for GOFAHOP, it is advisable that the weight of the main twin bendable handlebars be always commensurate with the combined weight of GOFAHOP's base and her bin.

As such, we surmise that GOFAHOP should be 8 pounds heavy or less, with twin bendable handlebars that are 3 pounds in weight or less. To play it safe, GOFAHOP should be built strongly enough to withstand a maximum load capacity of 10-20 pounds of tennis balls. We can however safely estimate that her bin will never be filled up with tennis balls that heavy, even when filled to the brim. Here, the operative word is load-capacity, referring to the limits she can go, and not so much as the real load itself. We may never reach such load capacity. No pain or stress to the arms, back or spine is our goal.

The grates of GOFAHOP's movable trapper (nos. 12B) should be metallic in nature, with a slim slightly robust surrounding metal frame (no. 12A) on all 4 sides. The movable-trapper's liners or grates (no. 12B specifically,) though metallic in nature (steel) should be slightly flexible, or elastic enough to allow tennis balls to go through, but with a holding power, so that tennis balls do not fall out of the bin, after they have been trapped and retrieved. This is one good reason why we prefer a metal base, with reliable holding power and resilience for all GOFAHOP's internal mechanisms.

Her smaller connecting bars (nos. 9A and 9B) which push down on the movable trapper directly, could be metal; or plastic of a dense (solid but non-heavy) nature, with the ability to rotate and mesh into the main handlebars (nos. 2A and 2B) different from other derivative versions of GOFAHOP.

The cylindrically shaped rotating compartments (nos. 3A and 3B) around the horizontal crossbar (no. 5) attached to GOFAHOP's main frame, must have a hollow center and a rotational ability to help facilitate GOFAHOP's bin into a standing position. However, at some point, it should be able to click to a stop . . . and stay put, keeping the basket standing at varying adjustable waist levels.

Her main handlebars (nos. 2A and 2B) can be metallic as well and should have a pair of semi hollow compartments (nos. 10A and 10B: FIGS. 1 to 3C only)—at a lower-level point—that can contain the smaller pronating bars (nos. 9A and 9B) which detaches from the movable-trapper, comes upward to mesh into the main twin handlebars, in preparation for the rotational standing position. One way to describe this hollowed out compartment on (nos. 10A and 10B) is that it has sort of a half-shell look. This is necessary because we have fashioned the main handlebars, with the ability to rotate the entire bin filled with tennis balls, into a full standing position, at an adjustable, comfortable waist level. Again, this is different from the ensuing derivative versions of GOFAHOP.

However, if the construction engineer deems it fitting to make the handlebars with dense metal materials, that is equally acceptable. Our only requirement is that the handlebar's weight should not be too heavy; but should be commensurate with the combined weight of the bin and the hauler—which should be well built-since it holds in place and originates not only the main handlebars, but also contains the improved movable-trapper, the 4 arches, the 4 springs, the spring's components and the 4 wheels.

GOFAHOP is certainly scalable to size (large or small) depending on the number of tennis balls one is willing to collect during practice sessions. To this effect, we would like to mention very quickly here, that we have blown out GOFAHOP into various innovative designs, as natural flows from the primary idea, the ALPHA, if you like, and at various sizes. They are listed below in a table format:

THE VARIANT SERIES OF GOFAHOP AND
HER MODIFIED ALTERNATE VERSIONS

| GOFAHOP | GOFAHOP 300 | GOFAHOP 500 | GOFAHOP 1000 |
|---|---|---|---|
| MODIFIED ALTERNATE | M.A.G. I-300 | M.A.G. I-500 | M.A.G. I-1000 |
| GOFAHOP-1 | | | |
| MODIFIED ALTERNATE | M.A.G. II-300 | M.A.G. II-500 | M.A.G. II-1000 |
| GOFAHIP-2 | | | |
| MODIFIED ALTERNATE | M.A.G. III-300 | M.A.G. III-500 | M.A.G. III-1000 |
| GOFAHOP-3 | | | |
| MODIFIED ALTERNATE | M.A.G. IV-300 | M.A.G. IV-500 | M.A.G. IV-1000 |
| GOFAHOP-4 | | | |
| MODIFIED ALTERNATE | M.A.G. 1-B/S/P 300 | M.A.G. 1-B/S/P 500 | M.A.G. 1-B/S/P 1000 |
| GOFAHOP-1 FOR | | | |
| BASEBALL; SOFTBALL; | | | |
| FIELD HOCKEY, AND | | | |
| PICKLEBALL | | | |
| MODIFIED ALTERNATE | M.A.G. 1-G 300 | M.A.G. 1-G 500 | M.A.G. 1-G 1000 |
| GOFAHOP-1 FOR GOLF | | | |
| BALLS | | | |
| FUTURE GOFAHOPS: | Sit and drive | GOFAHOPS that | GOFAHOPS that |
| | GOFAHOPS. | operates with | operates with |
| | | rechargeable batteries | electrical power. |

Please note that the numbers 300, 500 and 1000 in the table above are in direct reference to the estimated number of tennis balls, baseballs, softballs, pickleballs, and golf balls that each variant bin can comfortably trap and contain. Please note also that they can be any given number. We are not stuck on numbers. GOFAHOP's bin can be stretched out or constricted at will . . . , to any given number/load capacity that is deemed comfortable to the user. We certainly want to give more fun time to our targeted clients, on the tennis or pickleball courts, on the baseball/softball fields and the swinging ranges for golf, with the intent on less and less time chasing these variant balls. GOFAHOPs are indeed very essential parts of—the next generation of ball hoppers!

Please permit us to reiterate here again that directly flowing out of the ideas of the above-mentioned series and their variations, we have created another idea of a different kind, which we titled-GOFAHOP-AIDER. The AIDER was alluded to above, in the last paragraph (0021) of the title, “BRIEF SUMMARY OF THE INVENTION: GOFAHOP,” on page 6.

GOFAHOP-AIDER is certainly built to fit any of the “traditional” tennis ball hoppers mentioned above. GOFAHOP-AIDERS are the alternate versions we designed and invented, as improvements to Wilson, Gamma or Tourna. We would be touching upon GOFAHOP-AIDER and her series in a separate patent application. GOFAHOP-AIDERs put simply, were created to aid the erstwhile “traditional tennis ball hoppers.” Hence, the nickname—The Aider.

At this juncture, please permit us also to introduce the fact that we have made the bold move to infuse our inventive idea into the arena of other sports type, introduced by distinctively different GRATE SYSTEMS. We shall see these separate and different grates described in FIGS. 12, 13, and 14 below, symbolically pointing to the direction we are headed, with the idea of GOFAHOP. These FIGS. 12, 13 and 14 (on replacement drawing pages 14/25, 15/25 and 16/25 respectively) are essentially a representation of the unique and distinctly differentiated grates systems of the various movable trappers/retrieval nests (nos. 12A and 12B) we have in mind, as we transition into the arena of other sport types. These grates shown in these figures below are responsible for the change in tide that led us to venture into the arena of other sport types and the eventual creation of the alternate version of GOFAHOP, described in FIGS. 10 and 11 on replacement drawing pages 12/25 and 13/25 found below, respectively. A change in tide to the extent that various grates sizes allow various types of sports balls to get trapped and retrieved by various movable-trappers. Please be aware also that this shift in tide took place, pre-non-provisional patent application for GOFAHOP, and as such, does not constitute any new matter.

Although there are no mathematical calculations involved in the selection of the grates (either by way of contraction or by way of expansion) they are treated simply as representations of their intended apparatus and versions of GOFAHOP. Please permit us to state that mathematical calculations will be done during prototyping and manufacturing. With this understanding in mind, we therefore move forward to say that GOFAHOP and GOFAHOP-AIDER are being further launched into other arenas as well. During one of our thought processes, we arrived at a decision that GOFAHOP, as an inventive idea, should not simply be limited to just tennis. We, therefore, ventured into applying the same concepts and creative ideas we had for tennis, to other sports such as baseball and softball, herein represented in FIG. 13, on drawing page 15/25 and by way of extension . . . with a little expansion of the grates . . . the sports of pickleball, that is now rapidly growing in popularity and gaining grounds all over The United States of America. FIG. 14, on drawing page 16/25, naturally fits in well as a representation of the movable-trapper's grate for golf. As we can see, the grates here are closer and tighter than the grates in the other two figures—12 and 13. The grates used for tennis (FIG. 12 on drawing page 14/25) can be applied to field hockey, with a little adjustment. All three grates in all three figures are portrayed as symbolically having different levels of expansion. They should have different tensions as well, since the different balls have different levels of weights and textures. The grates are all certainly amenable, depending on the type of sport and the type of ball they are being applied to. Therefore, the portraits or perspectives of these figures are simply a deliberate attempt to symbolically distinguish all six sports-tennis, field hockey, baseball, softball, pickleball and golf—but are not limited to these six alone. We know that with a little tweaking here and there of the GRATES of the new and improved movable-trapper, the idea of GOFAHOP can indeed be expanded, extended and applied to several different kinds of sports, especially baseball, field hockey, softball, pickleball and golf. We conclude this paragraph by stating that since grates where in our initial non-provisional application documents, this is no new matter, our usage of the tennis grates was thus in potency of being actualized and a pointer to the other sports types: baseball, softball, pickleball, field hockey and golf.

From the paragraph above, we probably already have a sense of the direction we the Ogofas are headed, with the idea of GOFAHOP. Without the slightest doubt, as we look into the future, we intend henceforth to pursue the application of the idea of GOFAHOP to BASEBALL, SOFTBALL, FIELD HOCKEY, PICKLEBALL, and GOLF. We took the liberty to search up “Dimensions.com” to get actual measurements of the various sports we are focusing our attention to; and below are our findings:
Baseballs have a diameter between 2.86″-2.95″ (7.3-7.5 cm) and circumference from 9″-9.25″ (22.9-23.5 cm). The mass of a baseball is between 5-5.25 oz (142 149 g) . . .
Softballs have a diameter of 3.82″ (9.7 cm) and circumference of 12″ (30.5 cm). The mass of a softball is between 6.25-7 oz (177-198 g) . . .
Field Hockey balls have a height of 2.81″; a diameter of 71.3-74.8; a circumference of 8.82″-9.25″ (22.4-23.5 cm). Material is solid plastic, with a dimpled surface.
Pickleball have a diameter of 2.874″-2.972″ (73-75.5 mm) and a circumference of 9.03″-9.34″ (22.93-23.72 cm). The mass of a pickleball is between 0.78-9.35 oz (22-26.5 g) . . .
Golf balls have a diameter of 1.68″ (42.93 g) . . .
Tennis balls have a diameter of 2.576″-2.7″ (6.54-6.86 cm) and circumference of 8.09″-8.48″ (20.6-21.5 cm). The mass of a tennis ball must be between 1.875-2.095 oz (56-59.4 g).
   . . . References: Dimensions.com

With the above calculations, it goes without saying that the different grates of the various movable-trappers must be built with an accuracy that allows for retrieval of the variant balls . . . but with a solid staying power, to contain the different sizes and weights of the variant balls. It also goes without saying that, since the terrain of baseball, softball, and golf are quite radically different from that of tennis, pickleball, and field hockey, their wheels will be built differently too, with the usage of springs, suspensions, shocks, hydraulics and/or a slight frame, such as we see in ATVs, but with some level of miniaturization. It also goes without saying that for golf . . . GOFAHOP would be more useful at Drive Ranges, as well as for private usage, and not so much as during a PGA tournament for instance. Maybe at a side range for warm-up purposes.

| BALL TYPE | TRAPPER | TERRAIN | WHEEL TYPE |
|---|---|---|---|
| TENNIS | GRATE: | HARD, | REGULAR WHEELS WITH BEARINGS/BRAKES |
| | 2.5″ | GRASS AND | |
| | | CLAY | |
| ++BASEBALL | GRATE: | GRASS AND | SPRINGS/SHOCKS/HYDRAULICS/SUSPENSIONS/BRAKES |
| | 2.86″ | FIELD | |
| SOFTBALL | GRATE: | GRASS AND | SPRINGS/SHOCKS/HYDRAULICS/SUSPENSIONS/BRAKES |
| | 3.82″ | FIELD | |
| PICKLEBALL | GRATE: | HARD AND | REGULAR WHEELS WITH BEARINGS/BRAKES |
| | 2.874″ | TURF | |
| GOLF | GRATE: | GRASS AND | SPRINGS/SHOCKS/HYDRAULICS/SUSPENSIONS/BRAKES |
| | 1.68″ | FORESTY | |
| | | BACKDROP | |
| FIELD | 2.75″ | TURF/GRASS | REGULAR: SAME AS TENNIS |
| HOCKEY | | | |

We recommend that a remodified version of MODIFIED ALTERNATE GOFAHOP I, as portrayed in FIGS. 10 and 11 above, be used for the sports of baseball, softball, and golf since she is uniquely positioned and most suitable for these sport types. We are thus introducing this version of GOFAHOP I as part of our line of products for all other sports. Furthermore, just as we did to the springs systems above, we are simplifying the reference characters of these unique wheels systems of these alternate versions, by renaming those entire embodiments, no. 0014, no matter where they are found. Please be aware that the reference character 0014 encompasses and includes the entire mechanism (both internal and external) without distinction, no matter where they are found. They all possess the same functionality.

There are three reasons why we recommend using this alternate version of GOFAHOP. (1.) A collection of baseballs, softballs, pickleballs or golf balls may be too heavy to lift, carry, and pronate into a standing position. (2.) This alternate version has a pre-existent in-built double inner bin (no. 14B) constructed to vertically slide up and down on two free standing bendable twin handlebars (nos. 2E and 2F) with the bins possessing the ability to clip into a standing position at waist level (nos. 2i and 2j) for ready ball practice. (3.) Because this version does not rotate or pronate, into a standing position; but rather has an inner bin (no. 14B) that slides up and down in a vertical manner, she is so much more suitable for the much heavier and denser balls of baseballs, softballs, and golf ball; and that is her great advantage. FIG. 10 is the proposed alternate version that serves as a real solution for these brands of sports. Her alternate set of vertical bars (nos. 2E and 2F) is well positioned to facilitate the vertical motion of the inner bin (no. 14B), separate and apart from the vertical bars (nos. 2A and 2B) that are used to push GOFAHOP around while collecting balls. As for pickleball and field hockey, their terrain is not too different from that of tennis and so they could use the kinds of wheels used by versions of GOFAHOP meant for tennis.

### CROSS-REFERENCES TO RELATED APPLICATIONS: GOFAFOP-AIDERS

(1) GOFAHOP-AIDER
(2) GOFAHOP-AIDER I
(3) GOFAHOP-AIDER II
(4) GOFAHOP-AIDER III
(5) GOFAHOP-AIDER IV

GOFAHOP-AIDERS are essentially the base variations of the GOFAHOP brand of ball hoppers. Though they have some resemblances to their antecedent derivative (mother) versions, as progenies, they differ from GOFAHOPs, because . . . , they come out of the factory without baskets of their own. They are in essence, invented and intended to be improvements for the erstwhile “traditional ball hoppers.” They work mechanically with springs, arches, wheels, and special handlebars; plus, uniquely reconstructed improved movable trappers, that has drop-down prongs/drive systems, thus further removing from the equation . . . the use of force, in ensuring that the trappers get to ground (surface) level. The differences in handlebars, the variations in sizes account for their uniqueness. They are intended to be mounted upon and dismounted, by the baskets of the erstwhile “traditional tennis ball hoppers.

It is, however, very easy for us to create our own detachable baskets for our AIDERS, if that becomes necessary. We are thus inviting the owners of the traditional hoppers to look at our AIDERS, because these aspects of our inventions are intended as improvements upon (aiding) Wilson, Gamma or Tourna; whichever of these entities may be interested in our Aiders.

Furthermore, since GOFAHOP-AIDERS were created with the sole intention of aiding “traditional” tennis hoppers, they therefore necessarily have within their base, clip-ons meant to hold down the mountable baskets of the “traditional hoppers,” while being filled up with tennis balls, which can also clip off before dismounting, after the said “traditional” baskets have been filled up with tennis balls. These clipping features do not pertain to GOFAHOP. They could also be fashioned to slide in and slide out too, with dual side to side horizontal (bottom) rail-runners with shutters (gates) at the front.

### AMENDED BRIEF DESCRIPTIONS and REPLACEMENT DRAWING SHEETS

Before we delve into the brief description of our drawing perspective, (and writing here in the first person singular) I would like to humbly appeal to my would-be examiner, to be a little lenient with me, since I never took classes in fine arts, beyond the levels of elementary school; I am neither an engineer, with a degree in engineering. It's been a very rough and tough journey, with difficult twists and turns, trying to understand and navigate the labyrinth of the very technical and difficult world of patent application, especially as a pro se inventor, who is venturing into such an exciting but difficult arena, for the very first time. I had to teach myself how to draw three dimensional mechanical drawings from books and from the internet, so I can present to you something worth looking at, and not just “stick” figures. So please look more at the concepts and overall ideas behind my perspective drawings, what I am trying to create, that which I am trying to achieve—the innovation and contribution, in some small way—that I am trying to introduce into the world of sports; and not so much as the aesthetics, appeal and “fine” prints of my crude elementary level drawings skills. It should be understood that not every single feature will be shown in every single perspective. Some items not found in one figure can be found in other figures. We don't always draw every single feature or item in every single portrait. If we do so, the perspectives would be overcrowded and confusing. We tried to portray the features that are necessary to point out exactly what each perspective is specifically highlighting, as we work toward depicting one big, unified wholesome picture of the entire invention and what she could potentially do. I want to thank you—my would-be examiner—in advance, for your time, as we move forward with the descriptions of the drawing perspectives.

FIG. 1: FIG. 1 on drawing sheet 1/25 is the perspective we have chosen as the publication picture for GOFAHOP and all her derivatives. This decision, however, is subject to change at any time, especially if our examiner sees fit otherwise. Right off the bat, you can notice that this figure/perspective makes a distinction between GOFAHOP's main bin (no. 14A) and her hauler (no. 001.) You can also see that this figure has been amended to portray the drive-prongs (no. 6DS) to show that feature as specified in our specification above. This shall be a continued pattern with the rest of the descriptions. The reference characters 8E and 8H are depictions of the bearings of GOFAHOP's wheels system, which makes for easy rotational movement around the tennis courts. In some figures, there are four such bearings on all four wheels of GOFAHOP's bins. We cannot see no. 8G, presumed behind the bin, in the other corner. No. 6DS is the remodified prong system that helps drive the movable trapper (nos. 12A and 12B) to surface level for ball retrieval. We do see the arches (nos. 4A and 4B) that allow balls to get under GOFAHOP's bin. All GOFAHOPs run on wheels here portrayed by nos. 13A, 13B and 13D. We cannot see no. 13 C. We also see that this version of GOFAHOP possesses a unique handlebar (nos. 2A and 2B) that can bend at (nos. 2C and 2D) and pronate into a standing position. This figure is a replacement drawing sheet.

FIG. 2: This figure is a portrayal of the front view of GOFAHOP. The initial FIG. 2 has been deleted and not included in this current substitute specification. It was simply too repetitious-a portrayal of the same figure in different perspectives. The current figure (now FIG. 2) was originally FIG. 3. It has all the features described in “The Detailed Description of GOFAHOP,” namely: (a.) the arches (nos. 4A, 4B, 4C, and 4D)—(b.) the movable trapper/retrieval nest (nos. 12A and 12B)—(c.) the 4 durable springs and their compartments here portrayed as (nos. 7B, 7C, 7D; with 7A behind GOFAHOP's leg) assumed to be behind 13A—(d.) the cylindrically shaped rotating hubs (nos. 3A and 3B)—(e) the contiguously extending horizontal bar (no. 5) that laps around behind GOFAHOP's frame (not touching the body of the bin) but is attached to the side corners of the bin (no. 14A), with enough room to give stability to the 2 rotating cylindrical hubs (nos. 3A and 3B) and; (f) the two distinct detachable, pronating, vertical but horizontally contiguous smaller bendable bars (nos. 9A and 9B)—(g) the horizontal bars (nos. 6A, 6B, 6C and 6D) that presses down on the drive-prongs (no. 6DS)—and finally, the unique bendable twin handlebars (nos. 2A, 2B, 2C and 2D) which when pushed forward moves GOFAHOP, and when pushed downwards, automatically put into motion, the aforesaid chain reaction and desired result of filling up GOFAHOP with tennis balls. This figure, as in all figures, shows that GOFAHOP rolls on a set of 4 wheels. It also possesses ancillary wheels as we shall see in FIGS. 3A, 3B and 3C below, which essentially are partial portrayals of this same version of GOFAHOP. We can see that only this version has the crescent shaped hollow (no. 10A and 10B) into which the pronating vertical bars meshes.

FIG. 3A: This figure begins to demonstrate the direction of movement of the necessary connecting pieces, when the user has collected all tennis balls and is ready to bring GOFAHOP into a standing position at waist level, for ball practice. The first stage is to bring the pronating twin contiguous vertical bars (nos. 9A, and 9B) to mesh into the semi oval compartment (nos. 10A and 10B) of the main handlebars, as portrayed by the upwards moving broken arrows. The second stage is to bend the upper parts of the main handlebars, which contains the ancillary wheels . . . as portrayed by the outward projecting broken arrows. Here the ancillary set of wheels are hidden because they are presumed to be on the other side of the main handlebars . . . the forward-facing side. You can notice that we made the drive-prongs (no. 6DS) more noticeable which gets pushed down by the horizontal bars (no. 6C) with the effect of driving the movable-trapper to ground level for the collecting of tennis balls off the surface of the courts.

FIG. 3B: This figure demonstrates the third stage of GOFAHOP's transition into a standing position. At this stage, we begin to see the secondary essence and usefulness of the rotating cylinders, nos. 3A and 3B. This figure also shows that GOFAHOP has a separate set of smaller supporting wheels (nos. 13E, 13F, 13G, and 13H) on the handlebars for mobility around the tennis courts, when GOFAHOP has been filled up with tennis balls. We propose that during prototyping or manufacturing, an improved and perfected set of these ancillary wheels will be as miniscule as possible or almost invisible, able to move GOFAHOP around with ease, without scraping the handlebars and/or scratching the surface of the tennis courts. Roller-ball kinds of wheels, if necessary, should be used. This figure portrays some of the essential mechanisms such as the arch (no. 4B and 4C) necessary to allow tennis balls to go under GOFAHOP with ease.

FIG. 3C: This figure portrays GOFAHOP in a full standing position at waist level, supposedly filled with tennis balls. As you can see, GOFAHOP's unique handlebars (nos. 2A and 2B) were able to pronate into a standing position because of her rotating cylinders (nos. 3A and 3B) on a single horizontal bar (no. 5) and because she has joints (nos. 2C and 2D) that enable her to perform this feat. GOFAHOP should be built with the best joints there are, so that she can withstand the rigors of user mileage and the test of time. We see the ancillary wheels (nos. 13E, 13F, 13G and 13H) which help facilitate mobility around the tennis courts. This figure marks the end of the first version (Alpha if you may) of the GOFAHOP series.

FIG. 4: This figure is a portrayal of MODIFIED ALTERNATE GOFAHOP I, a version we temporarily took away for a brief while off of our application documents. However, the way the frontal parts of her grates, that is, the movable-trappers (no. 12B) were designed, stands as physical evidence and a pointer to the initial existence of and the idea of the drive-prongs (no. 6DS), and how this system evolved into what it is today. It inspired the drive-prongs. We therefore decided it was Important to resurrect this figure because of the important role this perspective plays in the current supplemental specification of our application documents, as evidence and a testimony that this is no new matter. This figure marks the beginning phase of an entirely new strand of GOFAHOP. This figure also inspired (pre-non-provisional application) the creation of the double twin vertical bars found in the very next figure—FIG. 5—a version that could be used for tennis, pickleball and softball. In FIG. 4 we shall quickly notice that the major difference and point of deviation of this alternate version from GOFAHOP herself (Alpha) is the fact that she does not need pronating handlebars to come into a standing position. This is so because her inner bin (no. 14B) vertically slides down and clicks into her outer bin (no. 14A) in preparation for the process of collecting tennis balls; and then vertically slides back up, filled with retrieved tennis balls ready for practice on the tennis court. Moreover, she does not have contiguous horizontal bars (nos. 6A, 6B, 6C and 6D) over her movable trapper, because we wanted direct contact of the vertical bars (nos. 9A and 9B) with the linings (no. 12A) of the improved movable trapper; as well as direct contact of the linings of both inner (no. 14B) and outer (no. 14A) bins. Depending on the given situation, these linings could be used interchangeably with the horizontal bars (nos. 6A, 6B, 6C and 6D) to perform the same function. The concave base of the inner bin (no. 15) which also had the ingredients for and did inspire the prong systems too, fits perfectly well over her rotating cylinders (nos. 3A and 3B) which makes for easy retrieval of tennis balls. These cylinders are slightly smaller, and they are significantly lower here than in the other versions of GOFAHOP. However, her handlebars are bendable (nos. 2C and 2D) for the simple purpose of transportation and storage, after both bins are meshed, and she doesn't need ancillary sets of smaller wheels in her handlebars. She has a lid to prevent her tennis balls from rolling all over during transportation. All GOFAHOPS have lids. For us, the Ogofas, having lids should be standard or routine (to be expected) and not something worth wasting time claiming. Lids could be any shape or design too.

FIG. 5. This figure as we can see, was inspired by FIG. 4 above. This figure is simply the back and side view of MODIFIED ALTERNATE GOFAHOP I described above in FIG. 4. However, as you can presently see, it is an improved version because of the added extra twin handlebars (nos. 2E and 2F) which doubles with the original twin handlebars (nos. 2A and 2B) making it a total of 4 vertical bars.) We would say also that this figure is also related to FIG. 10 below. We made this major modification here because we wanted these additional twin sliding bars (nos. 2E and 2F), to take on the responsibility of vertically sliding the inner bin (no. 14B) in an up and down motion, thus bringing the inner bin filled with balls to waist level. We surmised that separating these features makes for a better functioning of the handlebars. Bars nos. 2A and 2B still continue to serve as the lever for moving our hopper and picking up tennis balls with the aid of the cylindrical hubs (Nos. 3A and 3B) while bars nos. 2E and 2F now assume solely, the vertical movement of this version's bin . . . , no. 14B. Nos. 9A and 9B have the ability to hook unto the inner bin (14B) when it's down, pushing it to the ground for ball retrieval. It can also get unhooked and pronate away from the horizontal bar (no. 6C) before the inner bin slides up to waist lever for ball play. In this version, we did not draw the drive-prongs, but we want to assume that they are there. We shall see the drive prongs in FIG. 10. The other modification to this version is the fact that the grates (nos. 12A and 12B) of the remodeled movable trapper, can only be found in the upper-inner-bin (no. 14B), thus leaving the bottom-outer-bin (no. 14A) completely open and free. This makes for an easier downward drive of the prongs (no. 6DS) to collect tennis balls off the surface of the tennis courts without any hinderance. The concave base of the inner bin (no. 15) does not touch the rotating cylinders (nos. 3A and 3B) and the drive-prong are assumed to protrude far out enough not to touch the cylinders, the spring compartments or the flat panels, making the movable trapper function properly in easy ball retrieval. To see the drive-prongs, please refer to FIG. 10 below. These two figures are almost identical. The only real difference is in their wheels systems and the type of balls they're meant to retrieve. The cylinders in this version are smaller anyway than the ones found in GOFAHOP Alpha, and that found in FIG. 10 as well, which have a higher elevation. These cylinders are significantly lower here than in the other versions of GOFAHOP. However, all vertical bars are bendable (at nos. 2C, 2D, 2G and 2H) for the simple purpose of transportation and storage, after both bins are meshed, and she doesn't need ancillary sets of smaller wheels in her handlebars like we have in the first version. She has a lid to prevent her tennis balls from rolling all over during transportation. It's a natural understanding that all GOFAHOPS have lids.

FIG. 6: This figure is a portrayal of MODIFIED ALTERNATE GOFAHOP II. In this figure of this modified alternate version, we do see a very uniquely made handlebar (2A, 2B, 2C, 2D and 9A, 9B) that contiguously curves midway through, over the cylindrical hubs (nos. 3A and 3B) stemming all the way down to perform the vital task of pushing downwards on the movable trapper from behind. These handlebars do not need to detach from the horizontal bar (no. 6C) and the movable trappers (nos. 12A and 12B) as seen in GOFAHOP I above, because this version of GOFAHOP also . . . does not swing into a standing position. However, the main handlebars do fold over at nos. 2C and 2D, bending forward over the lid, for easy storage and transportation purposes. As stated earlier, this version also has a lid to protect the tennis balls during transportation. You can also see the prong system (no. 6DS) in between two horizontal bars (no. 6C) and (no. 12A) and of course no. 4B and 4C are the arches. Here, No. 12 A curves around the legs and spring systems of GOFAHOP to avoid friction, while picking up balls.

FIG. 7: This figure is a portrayal of MODIFIED ALTERNATE GOFAHOP III. In this figure, we see a radical change in the mechanism of the handlebars and the way they work. Instead of using rotating cylinders (3A and 3B), these unique handlebars use 2 twin sets of rotating pinions with cogs (no. 188 on both sides of the bin, no. 14A . . . ; and nos. 19A and 19B; all of which are attached to 17B and 16B again on both sides of the bin, no. 14A). These are called gears in some quarters. This time around we decided to portray her with an abridged handlebars (nos. 2A and 2B) which is a testament to the fact that every GOFAHOP product has elasticity and the capability to be remodified into different forms and shapes; a testament to the fact that parts can be used interchangeably. This version uses all the major or essential mechanisms of GOFAHOP as portrayed in the “Detailed Descriptions” above. Her handlebars do bend (at nos. 2C and 2D) for transportation and storage purposes. This figure also shows a remodified version of the drop-down vertical bar (nos. 9A and 9B) that has 2 horizontal fork-like prongs (nos. 9C and 9D) extending into an abridged short bar, that touches and presses down on of the newly improved movable trapper's horizontal bars (nos. 6A, 6B, 6C, 6D) and the prongs system (no. 6DS.) on all sides of the bin. These vertical bars (nos. 9A and 9B) do bend into twin contiguous horizontal fork-like prongs, possessing horizontal short bars, (nos. 9C and 9D) that do not detach from the movable trapper. In the perspectives of this FIG. 8, you cannot see reference characters 9A, 9C, 16A, 17A, 6C, 6D, 19A and 20A and the other 188. They are all presumed present on the other side of M.A.G. IV's bin.

FIG. 8: This figure is a portrayal of MODIFIED ALTERNATE GOFAHOP IV. In this version of GOFAHOP, we see another variation of a uniquely constructed handlebar, that also uses all the bottom or baseline features of GOFAHOP, but however, works differently from all versions of GOFAHOP, because her handlebars (nos. 2A and 2B) have sliders (nos. 18A, and 18B) with nos. 18C and 18D on the other side, that uses extra spring effects (nos. 7E, 7F, 7G, and 7H) atop her hauler (no. 001.) She also has vertical bars (nos. 22A, 22B, 22C, and 22D) which she uses to drive down the movable trapper to collect tennis balls, filling up her bin. We experimentally added the Drive Prongs (no. 6DS) to ensure that tennis balls are reached and collected. In this figure, we cannot see the cooperative reference characters (nos. 7G, and 7H) and (nos. 22C, and 22D) with similar functions, since they are on the other side of the drawing, within this perspective. What one can see on the drawing pages, however, are all indicative of the components that are hidden on the opposing sides of all perspectives. One can see that the handlebars have been abridged, making for easier folding, transportation and storage. No. 7D is a representation of the springs systems. It is the only one we can see in this perspective.

FIG. 9: This figure is the same version as FIG. 8 above. It is a new drawing that is meant to clearly show the components of this version. It is simply a portrayal of the working mechanism on the opposite side of FIG. 8; the side we could not see earlier. For example, the stoppers to reference characters 7G and 7H easily seen here, are considered a part of the slider systems hence there are no reference characters attached to them. They do prevent the sliders (nos. 18A, 18B, 18C and 18D) from going on indefinitely, as well as enabling them to get back in position, each time tennis balls are being retrieved.

FIG. 10: This figure is a representation of the version of GOFAHOP we have specially chosen to be used for various sports other than tennis, which we are transitioning into, also mentioned in page 35, paragraph 0096, FIG. 23 below. It is a portrayal of the newest and most improved version of GOFAHOP I streamlined as the hopper for baseball, softball, and golf. It sure is a direct remodification of ALTERNATE GOFAHOP I in FIGS. 4 and 5, and has a striking resemblance to them, even though they function differently and are used at different terrains. We use reference characters 14A and 14B for the dual bins of this version simply because of the special function they perform in conjunction with the wheels systems. No. 14A is meant to synchronize with no. 14B, and both together, are particularly meant to ultimately synchronize with the baseline horizontal bars (nos. 6C, 6B, 6A, and 6D) which here, in this version, in addition to driving down the drive-prongs, do perform the dual function of driving down the wheels systems of these versions of GOFAHOP as well, during ball retrieval. This way they can work effectively in meeting their objectives of first getting to the balls and secondly, collecting them with precision. The wheel systems are also a strong base from the ground up, to the mechanism of the entire bin. This version of GOFAHOP could also be used for tennis as well, with the changing or resizing of the grates. The major differences one can notice in this version are (1) the back of the outer bin (no. 14A) has been abridged, like an open concept; to help facilitate (without any hindrance), the working mechanism of the inner bin (no. 14B). (2) Instead of one set of twin handlebars as we had in GOFAHOP I, this version, like the improved FIG. 5, has 2 twin sets of bendable (vertical) bars (nos. 2A and 2B) and (nos. 2E and 2F). They look similar, but function differently. The inner bendable twin vertical bars (nos. 2E and 2F) are the bars that give support to the inner bin (no. 14B) . . . as well as functioning as the bar upon which the inner bin (no. 14B) slides down and up for ball collection and ball practice, respectively . . . while the original outer (also) bendable twin vertical bars (nos. 2A and 2B) retain the old function of serving as the push around and push-down handlebars. The abridged back of the outer bin (no. 14A) supports the now deliberately newly split and abridged twin horizontal bars (nos. 5A and 5B) which in turn support the twin cylindrical cones (nos. 3A and 3B). This deliberately abridged horizontal bars no. 5A and 5B behind this new open back concept of this version of GOFAHOP, help facilitate the working mechanism of the entire back-end system. Inside these cylindrical cones, we newly fashioned [pre-non-provisional] an inner spring system (nos. 3C and 3D) as a retractive device, that will help bring back the handlebars to an upright position, when the bars are in a dormant state and are not being used; this way the bars do not just flop down without support. These features of inserted spring systems within the cylindrical cones will now be used in every GOFAHOP and GOFAHOP AIDER products, with the hope that during prototyping and manufacture, they would be improved upon. Stemming down from the twin cylindrical cones are a twin (dual) vertical bar (nos. 9A and 9B) which pushes down onto the horizontal bar (no. 6C) with its drives (nos. 6DS) that in turn drives down the improved movable trapper (no. 12A and 12B) for the ultimate ball retrieval and fun play time or practice session. Notice here that the cylindrical cones are at a higher level than those of FIG. 4 above. Notice also that FIG. 10 has a lower grate-system than FIG. 4. The newly improved movable-trapper is different . . . , in that reference character no. 15 is like a square basin, with the grates at its bottom, interspersed (strewn) with inserted crescent shaped prongs (no. 6DS)—slightly shaded in this perspective, so it is transparent enough to see where the grates (no. 12A) meet the lining of the bars of the improved movable-trapper no. 12B. This lower-level basin like feature, is made possible due to the improved drive-prongs, which corrects the fear that without the arches,” . . . it would be practically impossible to collect the balls off the courts;” expressed early on, in our specification. Above and at the top of the inner vertical bars (nos. 2E and 2F) is a simulative representation of the inner bin, no. 14B (here portrayed with broken lines) depicting what the bin (full of balls) would look like, when it is hanging at waist level ready for ball practice. This bin with broken lines is not another bin. It is the same as the one below, hence the broken lines. We can see that the simulated bin is hanging on the two top-end hooks (no. 2i, and 2J) of the vertical bars 2E and 2F.

FIG. 11: This figure is simply an abridged blown-out version of the back right side of FIG. 10 above, as if facing this version from behind. We drew this partial perspective, more to portray the wheel systems which are not easily noticeable due to limited space on the drawing pages. This particular wheel system is also suitable for rough terrain, as we shall see below in the ensuing paragraphs and drawing perspectives. No. 0014, which is attached to the body of the frame (no. 14A) from the inside, with a split on GOFAHOP's frame (not noticeable from this angle) that allows the tires the freedom to go up and down; also has an internal conduit system with an internal spring system, that gives some buoyancy that makes the wheels able to bounce up and down (aided by the springs) in rough terrains; basically absorbing the shocks of the said rough ride. This same facility is equally used on the other side of the bin and on all the wheels that are not portrayed or seen in this perspective.

FIG. 12: FIG. 12 is a portrayal of the grates we have been using all along as the tracker for the new and improved movable-trapper for tennis, already seen in GOFAHOP and GOFAHOP-AIDER. This perspective in the portrayal of this grate, is only representative of what it should be; meaning there are no mathematical calculations involved yet. However, during one of our thought processes, we arrived at a decision that GOFAHOP, as an inventive idea, should not be limited to just tennis. We, therefore, ventured into applying the same concepts and creative ideas to other sports, herein represented by the next 2 separate and deferent grates sizes. You can see the reference character no. 12B as the grates themselves, and 12A as the linings surrounding the grates.

FIG. 13: is the representation of the grate systems we earmarked for baseball and softball, and with some tweaking here and there, to the sport of pickleball, which is gaining momentum all over The United States of America and in countries like Canada.

FIG. 14: In the portrayal of this perspective, this grate naturally fits in well as a representation of the movable-trapper's grate for golf. As we can see, the grates here are closer and tighter than the grates in the previous two figures—FIGS. 12 and 13. We begin to see now that all 3 grates are essentially representations of the unique and distinctly differentiated types of movable trappers/retrieval nests we have in mind, as we transition into the arena of other sport types. Although there are no mathematical calculations involved in these drawings yet, they are treated simply as representations of their intended apparatus or versions of GOFAHOP. Please permit us to state that mathematical calculations will be done during prototyping and manufacturing.

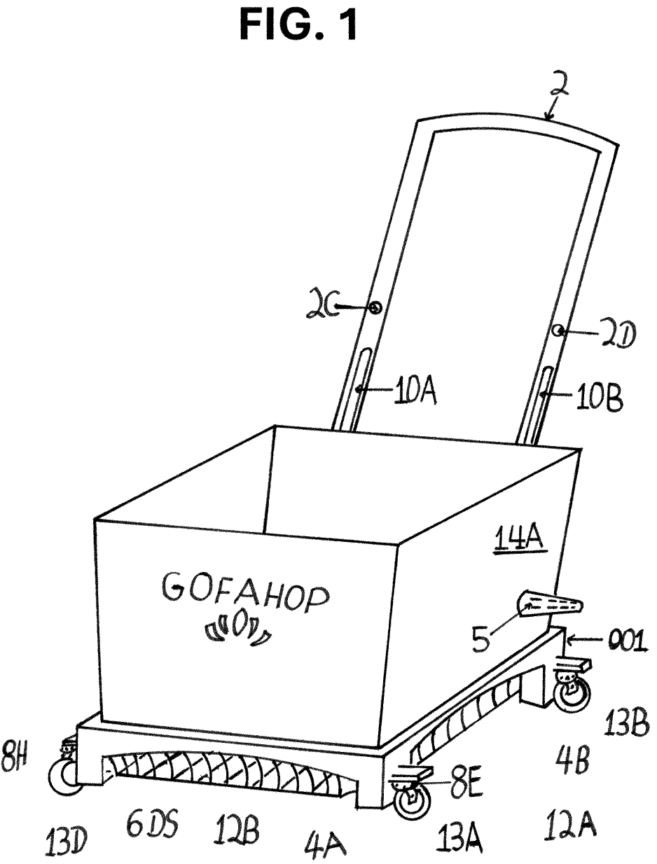

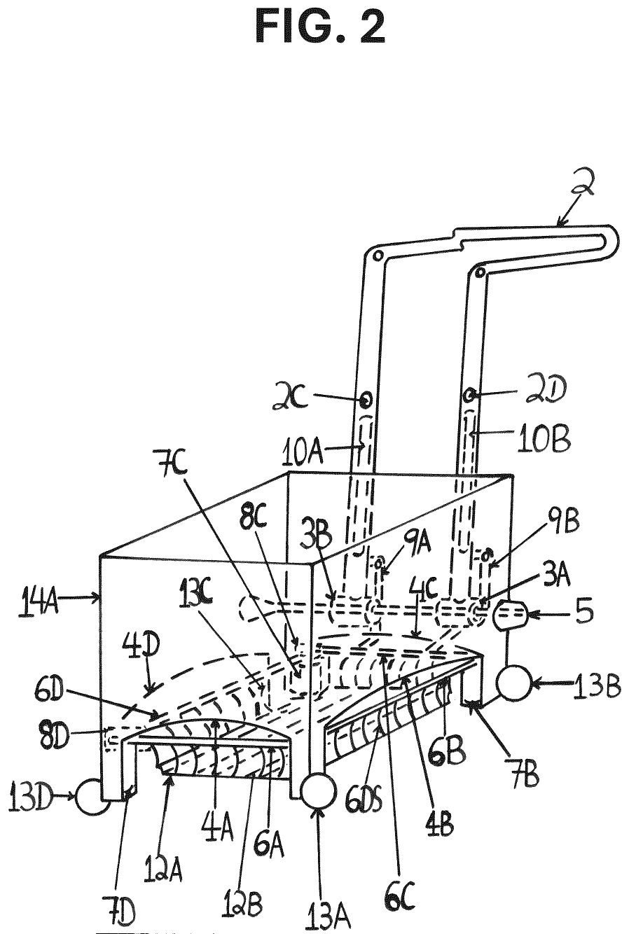

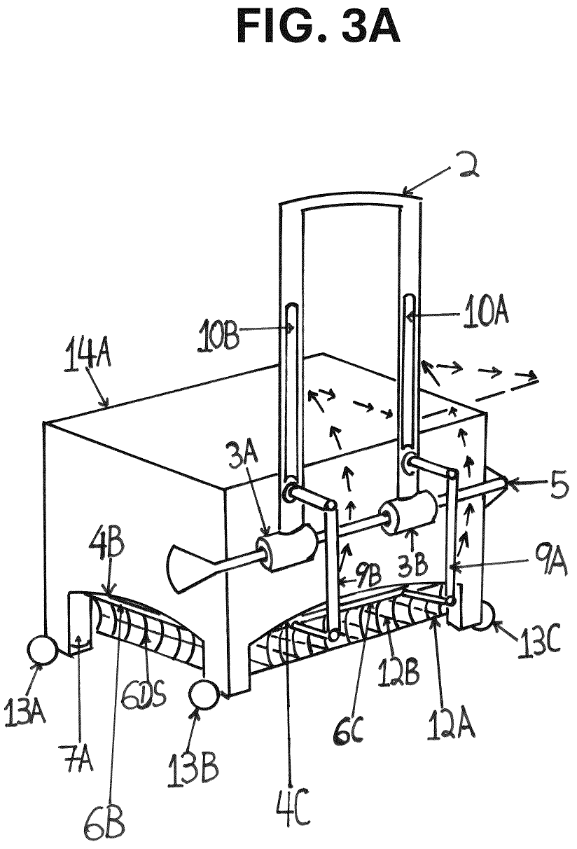

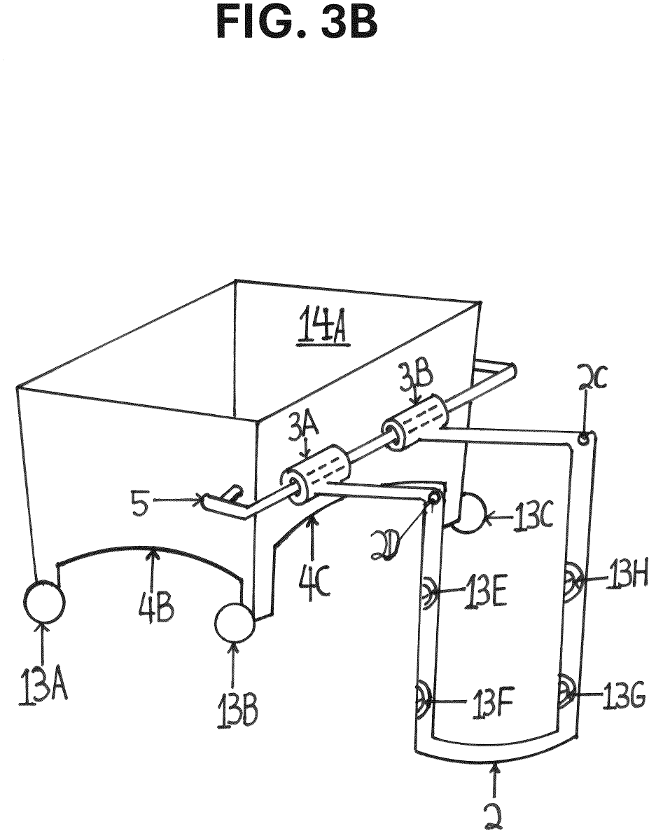

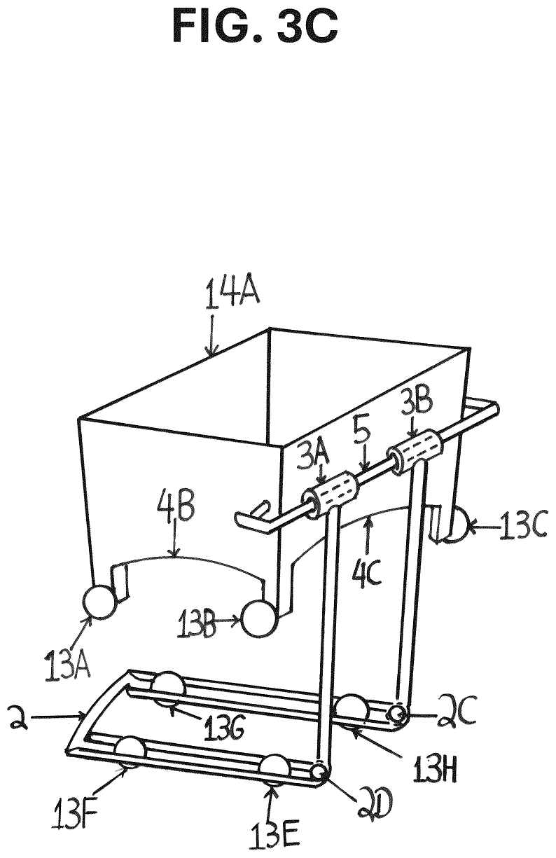

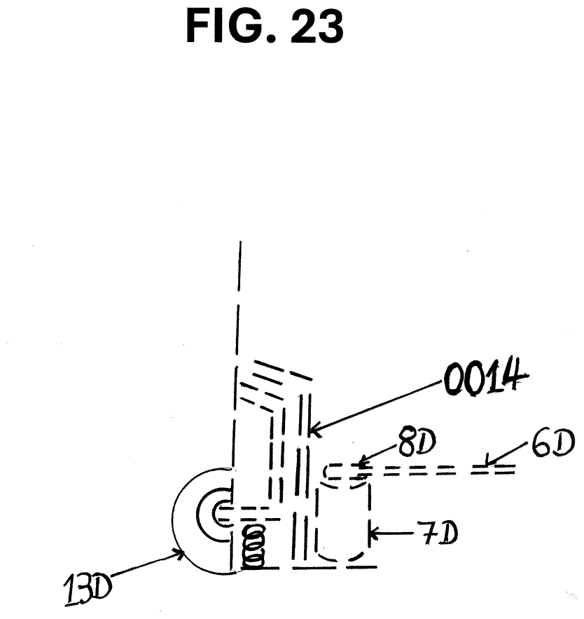

The next 7 figures; FIGS. 15, 16, 17, 18, 19, 20, and 21; are all portrayals of several essential components of GOFAHOP that should henceforth be used-on a need-to-use basis—for every pending hopper we have ever created and filed for, with the USPTO (GOFAHOPs and GOFAHOP-AIDERs alike) and far beyond the game of tennis, as we move forward into the arena of other sports. These figures are more like blown out features of majority of the figures above, that we propose heretofore, to be incorporated and applied to all future ball hoppers, on a need-to-use basis. They are simply blown out features, for we sometimes cannot easily and clearly see them in the drawn perspectives of figures above. Definitely, they are not new matters. Therefore, going forward beginning with FIG. 14, we have the following descriptions:

FIG. 15: In this FIG. 15, using reference character 8D as a representation, it symbolically portrays the 4 flat panels (which could be either round or square) over the 4 springs. We can clearly see that the spring in this perspective is covered up or encased within a rubberized tube (no. 77.) There is a total of 4 such springs encased within the greased tubes. In this figure, we can quite evidently see that the movable-trapper (nos. 12A and 12B) has a significantly pronounced portrayal of the newly developed drive-prongs (no. 6DS) standing free from the springs compartment; but standing tall and long enough to be able to reach and touch down to ground level, aided and supported by the horizontal bars (nos. 6A and 6D). Notice that reference characters 6A and 6D are here connected to each other, but also are connected to reference character 6DS, i.e. the drive-prongs. Note also that no. 6D is connected or embedded into flat panel no. 8D.

FIG. 16: This figure is a portrayal of the working mechanism of the springs' compartments. Here the main emphasis is on the split (no. 777) and how it helps facilitate the movement of other pieces such as the flat panel (no. 8D) sitting atop the spring (no. 7D) but is however connected to the horizontal bar (no. 6D). All these features are portrayed here at the beginning phase of the “drive down” of the prongs described in FIG. 15 above, which drives down the movable-trapper for the ultimate ball collection. Reference character no. 7PC is a portrayal of the protective case (which is what PC stands for) encasing and protecting the springs no. 7D and the rubberized tubes—reference character 77, shown above in FIG. 15—aided by the splits no. 777, on protective case 7PC. These features apply to all 4 legs of GOFAHOP, at all 4 corners wherein they are found—always in keeping with the same family structure and functions.

FIG. 17: is simply a portrayal of the downward movement of the above-described parts or components . . . when the main bendable handlebars are pushed downwards. This figure shows us how important the splits (i.e. nos. 777) are to this invention. Here we see portrayed . . . the already sinking or driven-down flat panel (no. 8D) within the protective case no. 7PC. The splits (nos. 777) of the protective cases (nos. 7PC) help facilitate the movement of all horizontal bars (i.e. nos. 6A, 6B, 6C and 6D) and thus the vertical bars as well, (i.e. the drive-prongs, nos. 6DS) and thus the springs, thus the movable-trapper, and thus ultimately the final retrieval of tennis balls; or any other sort of balls we choose to apply the idea of GOFAHOP to.

FIG. 18: This is simply a depiction of the hook system towards the top of the bars (nos. 2E and 2F) that the bin (no. 14B) hooks into to help keep it in place at waist level . . . , when the inner bin is full of balls and is ready for play or practice. It helps the bin to clip in and out easily.

FIG. 19: is a portrayal of the internal clip-on mechanism of and for the hook system above (nos. 2K and 2L) inserted within the walls of the inner bin (no. 14 B.) right at the top point where the bin (no. 14B) meets the vertical bars 2E and 2F, to hook up in preparation for ball play. This clip-on device looks and functions like a leaf-spring, found in certain musical instruments or on doors of cabinets. Its primary function is to ensure that the handlebars are secured in place but can be easily released as well. It is meant to help push in and/or push out the hook when the bin is lifted off the twin handlebars or a button is pressed down, if one is had.

FIG. 20: is an enlarged blown out portrayal of the same device in FIG. 19; showing the internal clip systems (nos. 2K and 2L) that help release the hook (internally) on the back of the bin when the inner bin is ready to be scrolled down for another round of ball collection. It could also help with the clip-on when the inner bin is full of balls and is ready to be hooked on to the bars for ball practice.

FIG. 21: This figure which we jokingly call the “moonshiner's flask”—is an abridged portrayal of the bin's wall (no. 14B) and a translucent depiction of the pin showcasing the inner system (no. 2L) as the bin rises upwards (portrayed by the broken arrows on either side) to get hooked on the top potion of the bar (for example, no. 2F) and actually hooked into no. 2i . . . just as it clips into place. It is essentially a clip pin. These clip pins can be easily unhooked, in very much the same way they got hooked up, by simply lifting the bin (no. 14B) or simply placing (or gliding) it down onto the hook.

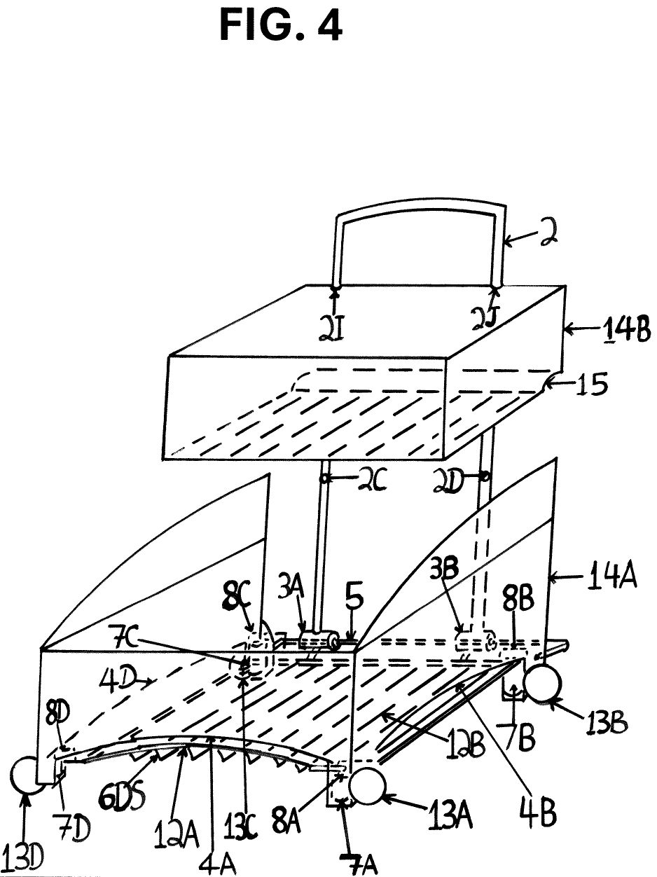

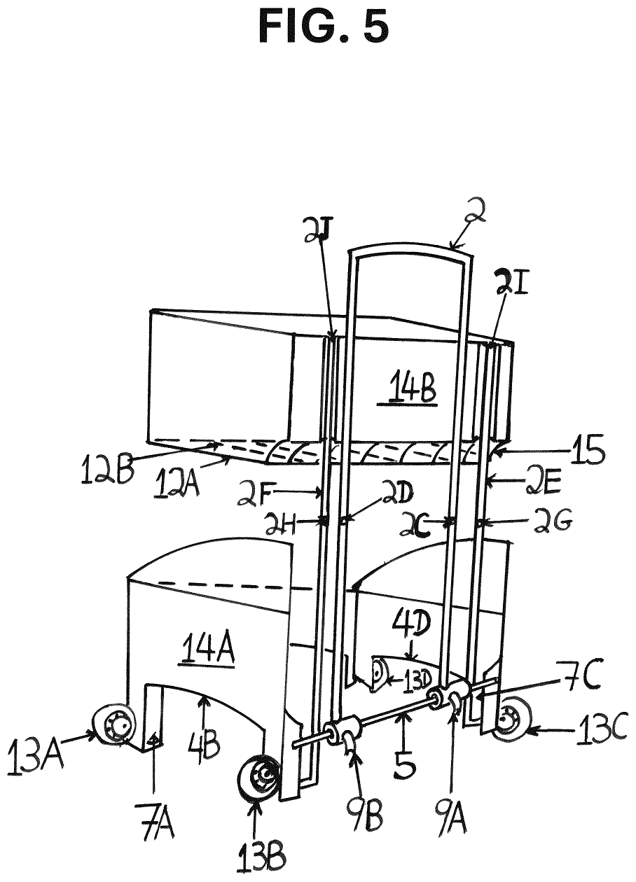

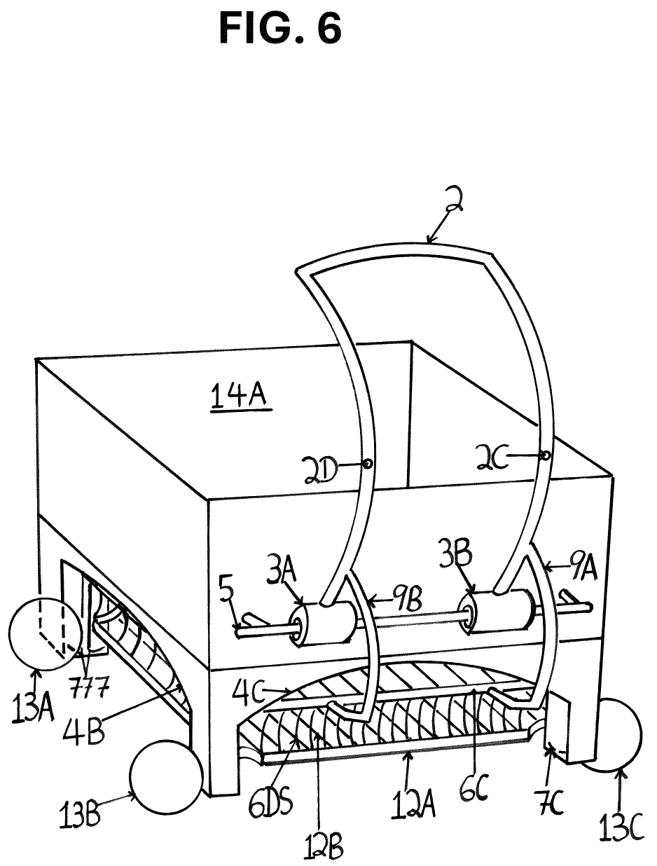

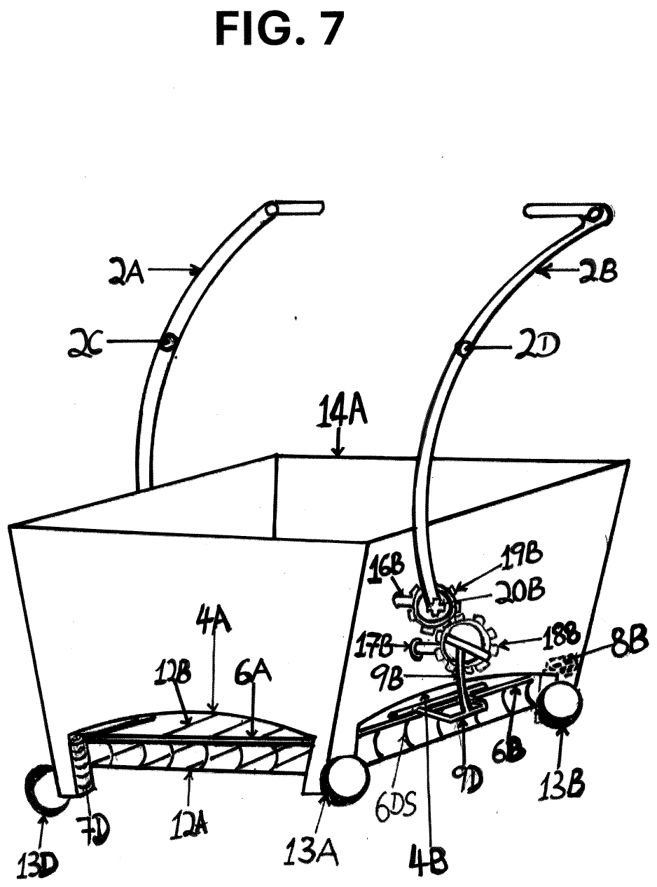

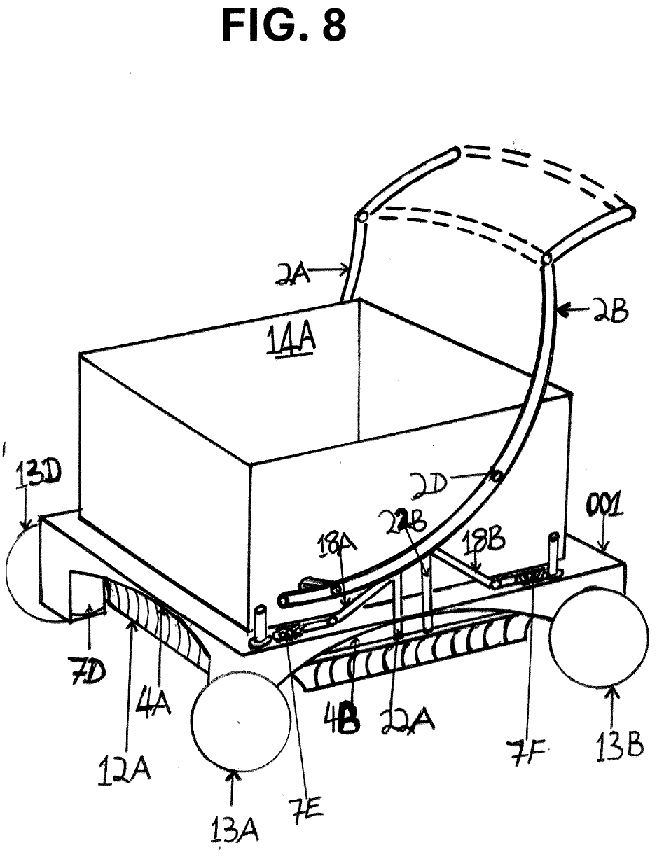

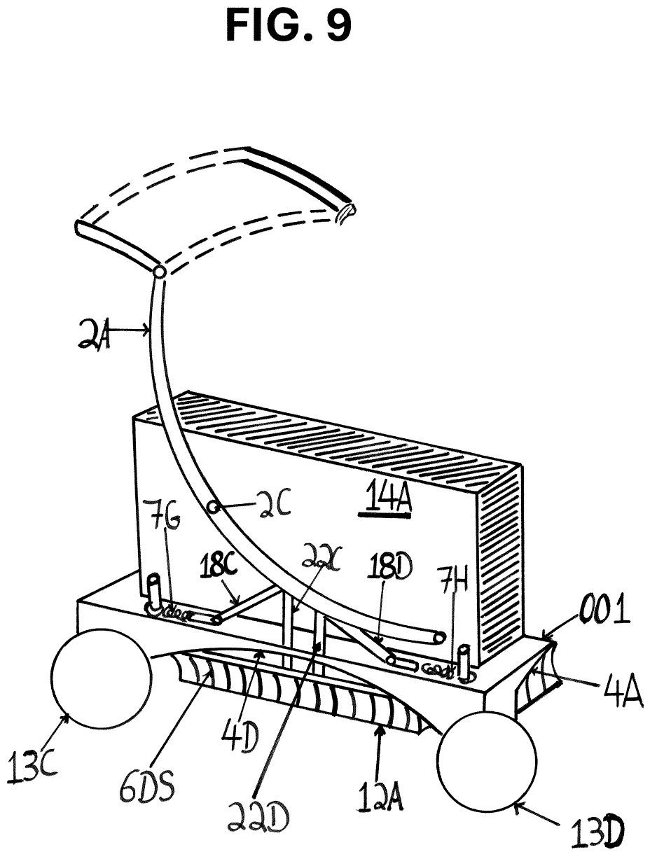

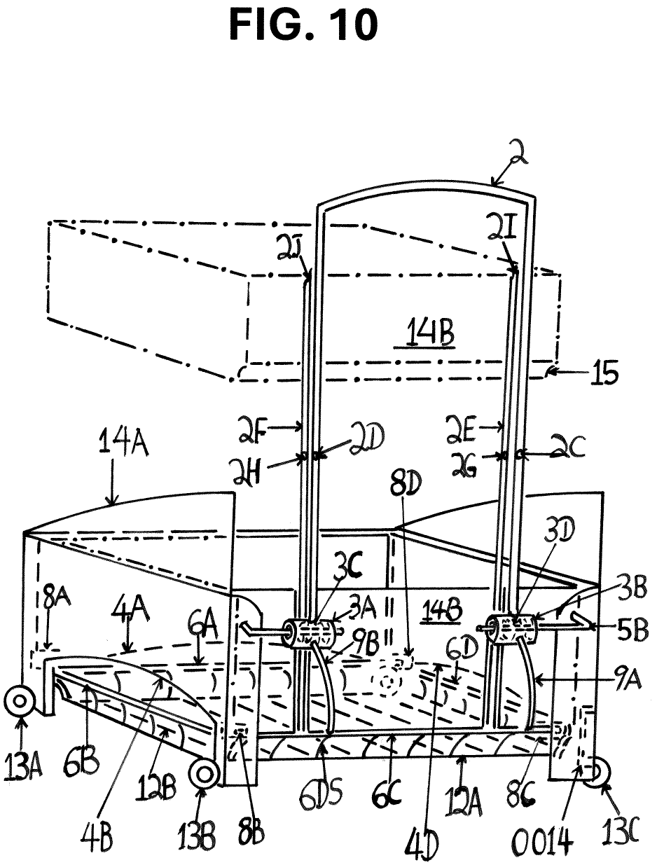

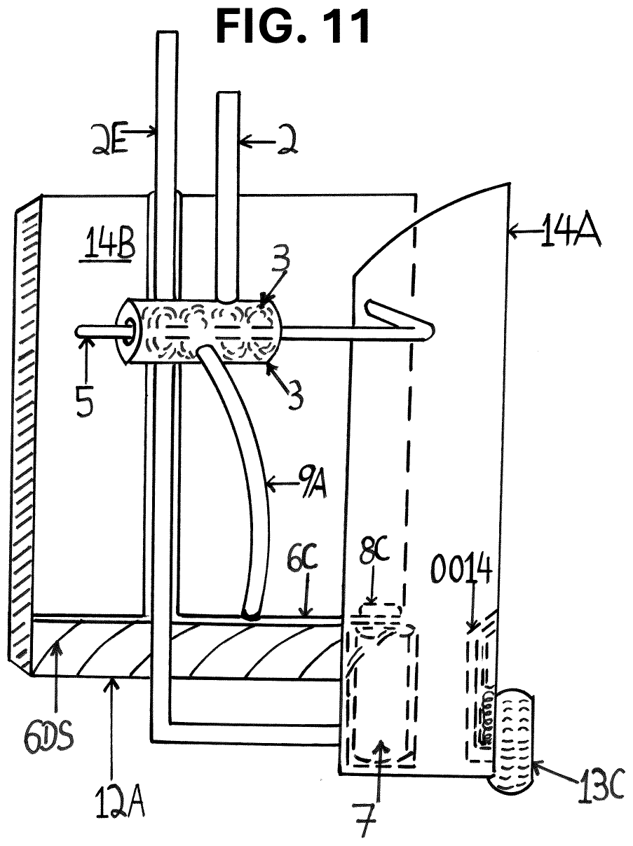

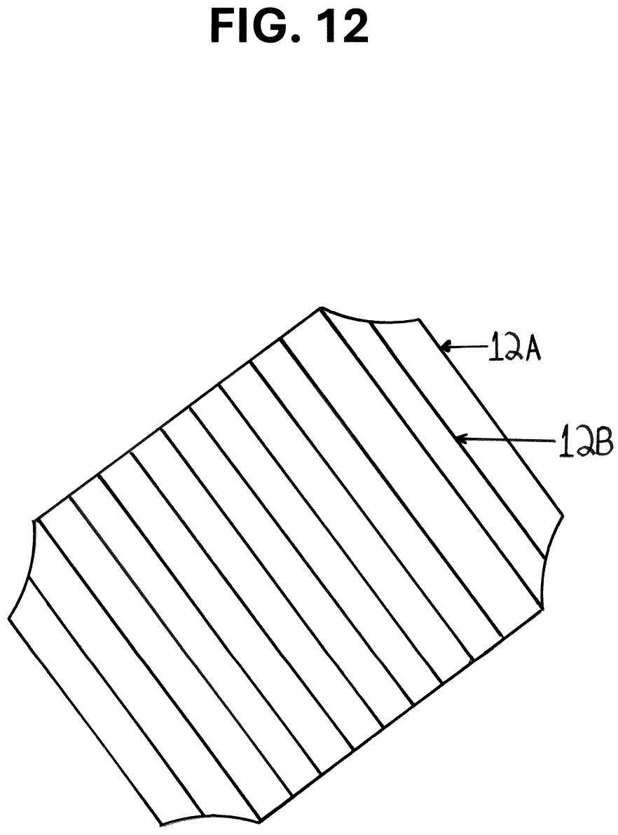

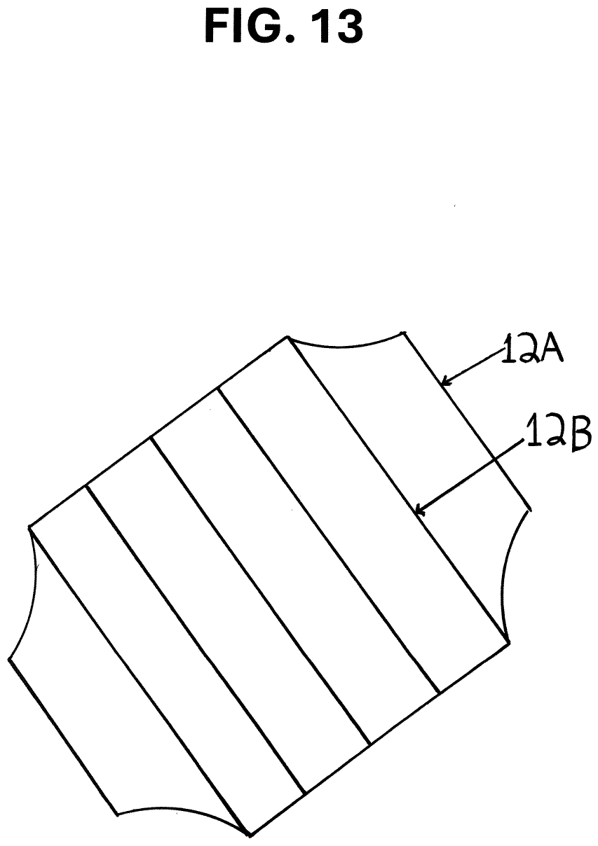

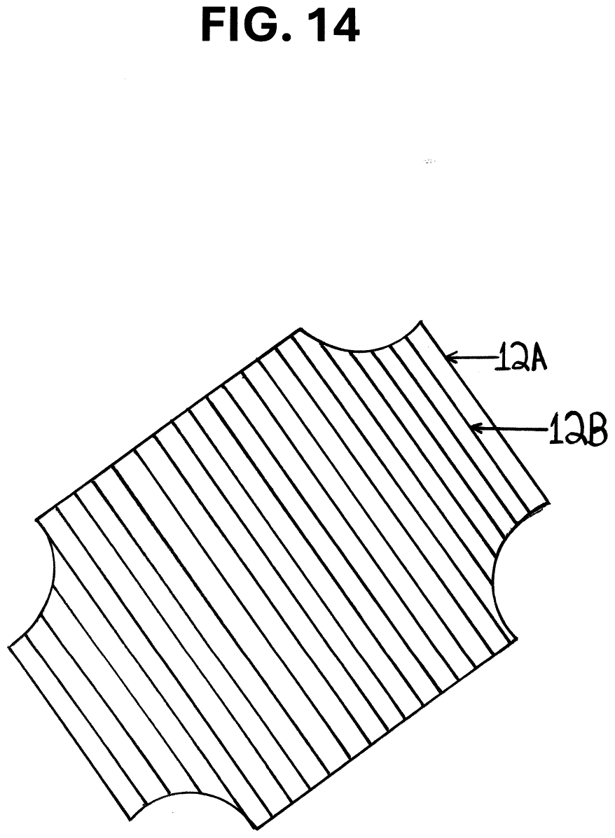

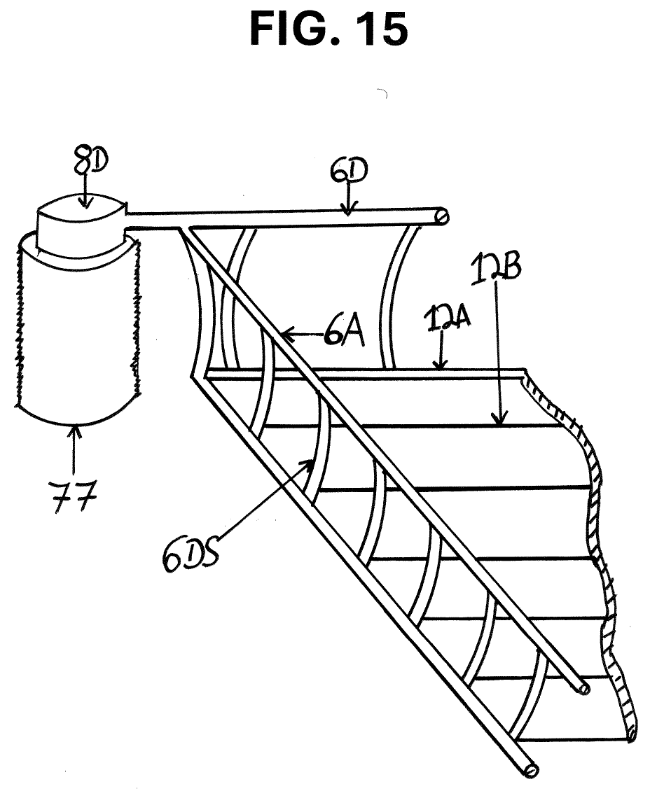

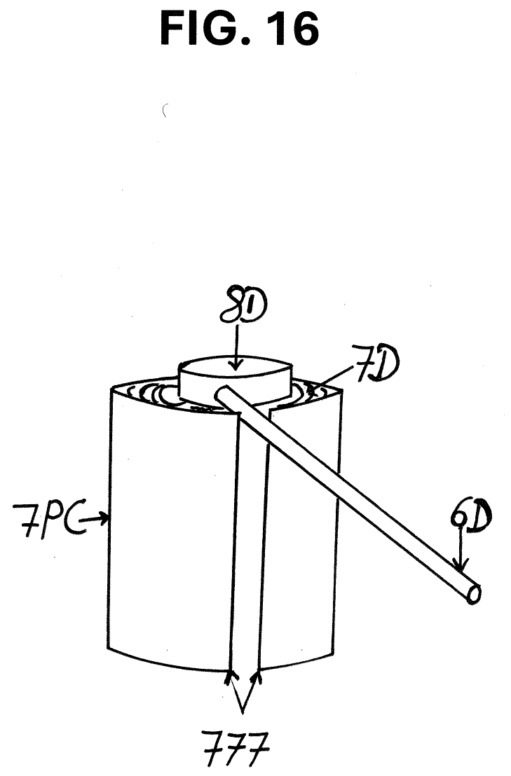

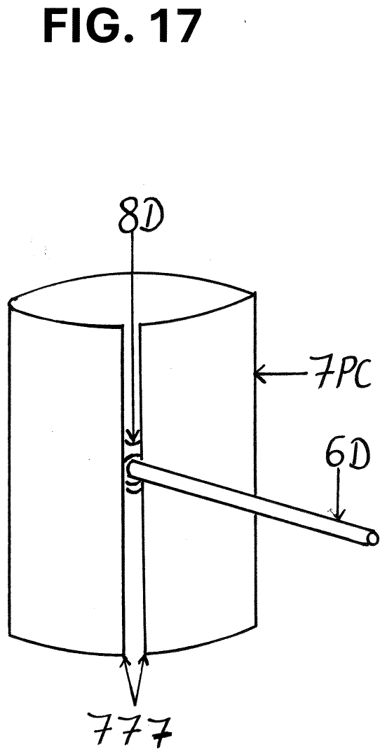

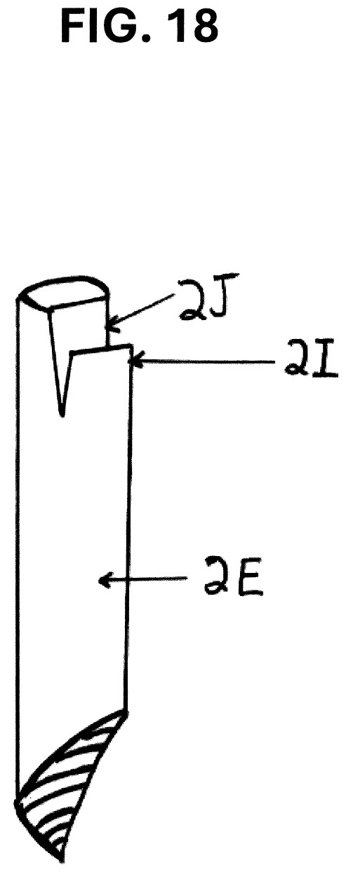

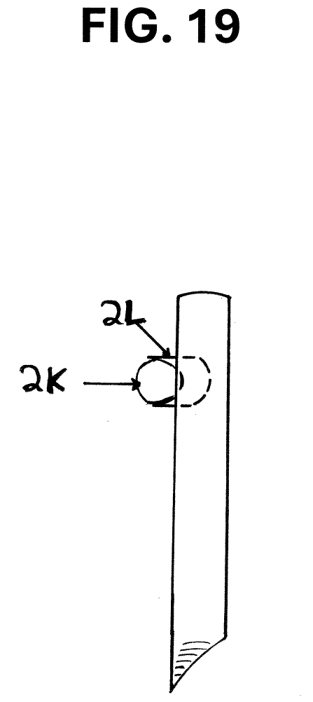

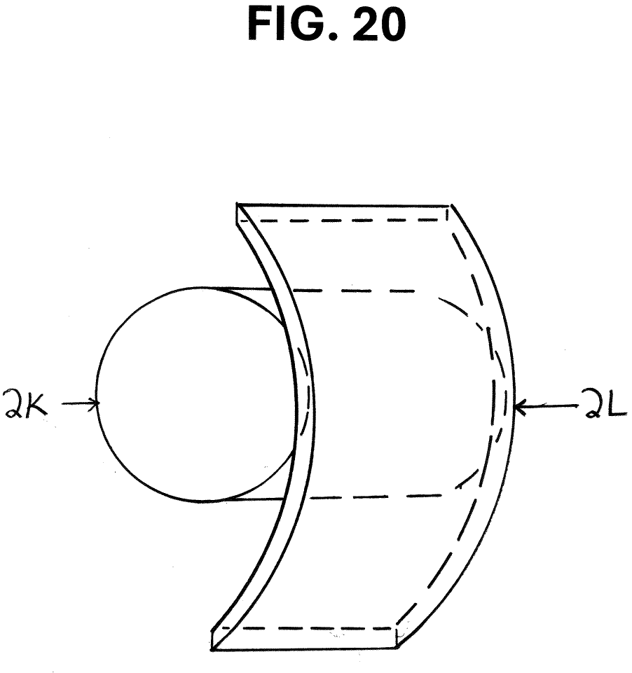

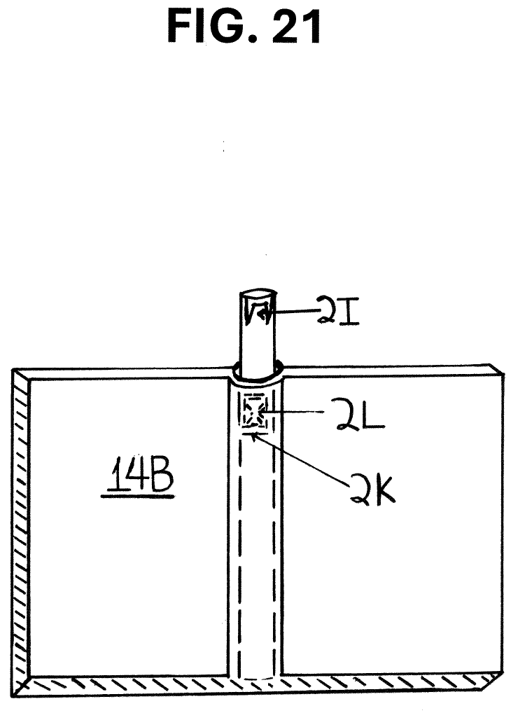

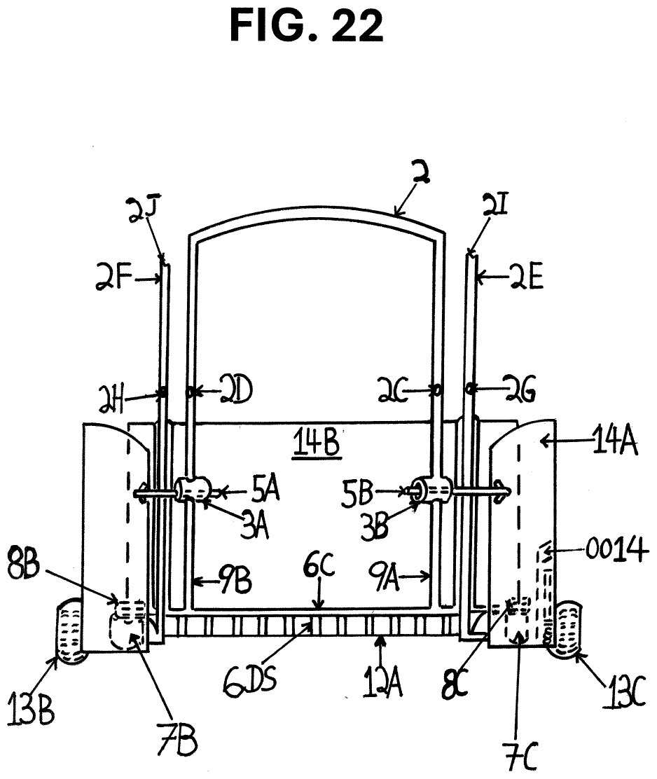

FIG. 22 on drawing page 24/25, is a straight out, flat “frontal” portrayal of the back view of FIG. 10. The main emphasis here is on the wheels systems. This perspective is meant to symbolically portray that this improved version of GOFAHOP I uses a different set of wheels owing to the different terrains she was invented to be used upon, for the various other sports. One can also observe that we solved a major problem—one of stability—by bringing down the twin supporting vertical bars (nos. 2E and 2F) to connect into the hind legs at almost base level on the main bin (no. 14A) that way her inner bin (no. 14 B) would have stability from the bottom up. Her arches are only found on her sides and front, and not on her back. This open concept helps with the functions of her back end. Since the drive-prongs (no. 6DS) of her movable-trapper extend beyond the wheel system in the shape of a crescent, it is thus easy to make for an allowance that precipitates a convenient and easy slide down of the bin's movable trapper (nos. 12A and 12B) touching ground level, to collect balls. Besides, these perspectives and versions (FIG. 10, FIG. 11 and FIG. 22) portray cylindrical cones that are much higher than her original alternate version (FIG. 4) and are supposed to be smaller in size to facilitate easy movements of her bins. The sliding motions are triggered by pushing down on her twin bars (nos. 2A and 2B) . . . , thus her rotating cylinders (nos. 3A and 3B) . . . , thus her vertical bars (nos. 9A and 9B) upon her horizontal bar (no. 6C) . . . , thus her prongs (nos. 6DS) and finally, the grates of her movable-trapper (nos. 12A and 12B) for the ultimate ball collection and fun play time. Though we may not see it, on the four sides of her outer bin (no. 14A) by her 4 wheels, there are 4 splits. Although you don't see it, reference characters 0014 are indicative of the splits on bin no. 14A, symbolically showcasing her inner protective walls for our improvised shocks systems in nos. 0014, which makes her wheels (nos. 13A, 13B, 13C and 13D) ride the bumps and frictions gallantly during ball collection. In this perspective, we cannot see all the features of nos. 0014; as well as reference characters nos. 13A and 13C . . . , because they are assumed to be situated on the opposite front side within the perspectives of this version of GOFAHOP. All of the above reference characters with the designations 13 series and 0014 series, are indicative of the type of wheel systems, each version of GOFAHOP uses for ball collection. The constructing engineers will know the best possible mode for achieving this requirement during prototyping and manufacturing.

FIG. 23 on drawing page 25/25, is a blown-out portrayal of the wheel system for GOFAHOP I designated as the version for the sports of baseball, softball and golf. Here we reconfigured and simplified her numbering style as just 0014. This way we keep things less complicated; for they are in truth, the same parts found at different corners of GOFAHOP's leg and bin.

### PREMISE TO THE BELOW STATED INDEPENDENT AND DEPENDENT CLAIMS ON PAGES 39, 42, 43, 44, 45, AND 46

Whilst the majority of “traditional tennis ball hoppers” we are erstwhile used to, involves so much physical strain in collecting tennis balls, GOFAHOPS's most distinct and particular claims, as works of original art, fell heavily on the fact that, their mechanisms work as an interconnecting chain reaction, in retrieving tennis balls, off the courts, with the simple push of a twin set of handlebars; that also serves the concomitant dual purpose of being a lever for trapping tennis balls, as well as, filling up her bins, without the repetitive exertion of sheer human physical force, entailed in the aforementioned erstwhile “traditional” ball hoppers.

Embedded within the below written 29 claims pertaining to GOFAHOP and every single variant version that stems from her, the above-mentioned mechanisms and interconnecting chain reaction, is brought to life. These mechanisms are the bane of GOFAHOP's existence as a creative idea; the core substance that fuels GOFAHOP as an invention. We intend to claim these very importance interconnecting features, simply because we feel they are germane to the very success GOFAHOP-namely: (A) her arch-shaped entrances for tennis balls; (B) her special single movable-trapper/retrieval nest; (C) her four very durable springs and their compartments, for a vertical rebounding up-push effect, that fills up her bin with the said tennis balls; (D) her cylindrically shaped rotating hubs (E) her contiguously extending horizontal bar behind her frame or bin; (F) her two distinct detachable, pronating, vertical but horizontally contiguous, smaller, bendable bars; and finally (G) her variant unique set of twin handlebars that automatically puts the entire mechanism into motion by a simple forward and downward push, giving leverage to . . . and filling up her bin; but concomitantly pronating into a standing position, for easy tennis practice.

Without these features, there is neither a GOFAHOP, nor is there an AIDER. Without these features, we wouldn't have the ancillary derivative alternate versions of both GOFAHOP and THE-AIDER. These features are what set our GOFAHOPs apart from the prior art.

Thus, in light of the same context (paragraphs 0091-0093) above, our former attorneys Mike Solomita esq, and Mark Tyson esq. of Norton Rose Fulbright LLP, drafted the ensuing missive as supporting expatiations as to the extent and scope of our specifications and claims regarding all GOFAHOP products: The above specification and examples provide a complete description of the structure and use of illustrative configurations. Although certain configurations have been described above with a certain degree of particularity, or with reference to one or more individual configurations, those skilled in the art could make numerous alterations to the disclosed configurations without departing from the scope of this invention. As such, the various illustrative configurations of the methods and systems are not intended to be limited to the particular forms disclosed. Rather, they include all modifications and alternatives falling within the scope of the claims, and configurations other than the one shown may include some or all of the features of the depicted configurations. For example, elements may be omitted or combined as a unitary structure, connections may be substituted, or both. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one configuration or may relate to several configurations. Accordingly, no single implementation described herein should be construed as limiting . . . and implementations of the disclosure may be suitably combined without departing from the teachings of the disclosure.

As used herein, various terminology is for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other, but can also indeed, become unitary with another element of the same invention. The terms “a” and “an” are defined as one or more unless this disclosure explicitly requires otherwise. The term “substantially” is defined as largely but not necessarily wholly what is specified (and includes what is specified, e.g., substantially 90 degrees includes 90 degrees and substantially parallel includes parallel), as understood by a person of ordinary skill in the art. In any disclosed configuration, the term “substantially” may be substituted with “within [a percentage] of” what is specified, where the percentage includes 0.1, 1, 5, and 10 percent.

The term “about” as used herein can allow for a degree of variability in a value or range, for example, within 10%, within 5%, or within 1% of a stated value or of a stated limit of a range and includes the exact stated value or range. The term “substantially” is defined as largely but not necessarily wholly what is specified (and includes what is specified, e.g., substantially 90 degrees includes 90 degrees and substantially parallel includes parallel), as understood by a person of ordinary skill in the art. In any disclosed implementation, the term “substantially” may be substituted with “within [a percentage] of” what is specified, where the percentage includes 0.1, 1, or 5 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise. The phrase “and/or” means and or. To illustrate, A, B, and/or C includes: A alone, B alone, C alone, a combination of A and B, a combination of A and C, a combination of B and C, or a combination of A, B, and C. In other words, “and/or” operates as an inclusive or. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements but is not limited to possessing only those one or more elements. Likewise, a method that “comprises,” “has,” or “includes” one or more steps possesses those one or more steps but is not limited to possessing only those one or more steps.

Any implementation of any of the systems, methods, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Additionally, the term “wherein” may be used interchangeably with “where”.

Further, a device or system that is configured in a certain way is configured in at least that way, but it can also be configured in other ways than those specifically described. The feature or features of one implementation may be applied to other implementations, even though not described or illustrated, unless expressly prohibited by this disclosure or the nature of the implementations.

The previous description of the disclosed implementations is provided to enable a person skilled in the art to make or use the disclosed implementations. Various modifications [and renditions] to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims. The claims are not intended to include, and should not be interpreted to include, means-plus- or step-plus-function limitations, unless such a limitation is explicitly recited in a given claim using the phrase(s) “means for” or “step for,” respectively.

1. A push around tennis machine, working as a chain reaction in tracking, trapping, and retrieving tennis balls off tennis courts . . . comprising:
01 a startup dual bendable push-around handlebars (nos. 2A-2B-2C-2D-2E-2F) that also serves as the main-lever which triggers and brings into effect, the chain reaction for the entire mechanism, comprising of and equally stemming from . . .
02 two cylindrical tubes (nos. 3A and 3B) that are held in place by,
03 one horizontal bar (no. 5) being held in place by the frame of GOFAHOP's bin (nos. 1A-1B-1C-1D) traversing behind and through the rotating cylindrical tubes,
04 the above cylindrical tubes (nos. 3A and 3B) furnishing the two main leveraging bendable handlebars (nos. 2A-2B-2C-2D-2E-2F) with the ability to rotate 180 degrees, completely bringing the tennis bin into a standing position, at waist level;
05 the above bendable handlebars further comprising a second pair of uniquely designed contiguously extending vertical, then horizontal and equally bendable twin smaller handlebars (nos. 9A and 9B) which touches down to push upon the ball collecting movable-trapper, further possessing the ability to both anchor on and anchor off-detaching from the pre-mentioned movable-trapper-pronating upward and clipping into the main handlebars (2A-2B-2C-2D-2E-2F) in preparation for the ultimate 180 degrees rotational standing position at waist level;
06 a single movable-trapper/ball-retrieval nest (nos. 12A and 12B) which presses down on the tennis balls, to trap, collect and fill up the bin;
07 another set of one contiguous conjoint bars (no. 6A-6B-6C) contained within and under the body-frame, but resting upon and pushing down from three sides, on the movable-trapper (12A and 12B), that is equally being pushed down by the pronating smaller bars (nos. 9A and 9B) from behind, further driving down the movable-trapper, giving it more leveraging downward push in collecting the tennis balls;
08 the bin comprising also of 4 arches (nos. 4A-4B-4C-4D) on all four sides; the arches being responsible for letting tennis balls through and under GOFAHOP's bin for the easy ball trapping and ball pick up;
09 GOFAHOP further comprising also of 4 very durable springs (nos. 7A-7B-7C-7D) directly underlaying the 4 panels of the movable-trapper (nos. 12A and 12B) giving a continuous, reciprocal, vertical up-push to the movable-trapper, after tennis balls have been collected;
10 the bin having four sets of wheels (nos. 13A-13B-13C-13D) making for easy mobility around the tennis courts;
11 and finally, a different and distinct set of smaller wheels (nos. 13E-13F-13G-13H) nestled within the main handlebars (nos. 2A and 2B) that makes for easy transportation on the tennis courts, after the balls have been fully retrieved and the bin is in a standing position.
